(19) United States
(12) Patent Application Publication
(10) Pub. No.: US 2008/0120325 A1
(43) Pub. Date: May 22, 2008

(54) Computer-implemented systems and methods for user access of media assets

(75) Inventor: Ruddman Davis, San Marino, CA (US)

Correspondence Address: JONES DAY, 555 SOUTH FLOWER STREET FIFTIETH FLOOR, LOS ANGELES, CA, 90071, US

(73) Assignee: X.com, Inc.

(21) Appl. No.: 11/601,456

(22) Filed: Nov. 17, 2006

(51) Int. Cl. G06F 17/00

(52) U.S. Cl. 707/102

(57) ABSTRACT

Computer-implemented systems and methods for handling media assets in a networked environment. Media assets located in a data store are searched and through use of a level of relatedness algorithm, a subset of media assets are returned to a user's device. The subset of media assets are displayed in a tiered arrangement to a user.

### TECHNICAL FIELD

This document relates generally to computer network access systems and more particularly to computer network media asset access and retrieval systems.

### SUMMARY

In accordance with the teachings provided herein, systems and methods for operation upon data processing devices are provided access digital assets over one or more networks. As an illustration, systems and methods can be configured for operation upon a processor-based device having a processor for retrieving media digital assets. The media assets are automatically displayed as tiers of interface items (e.g., widgets) on a display device.

A first widget is displayed on a first tier on the display device. The media digital asset associated with the first widget is directly displayed to the user through the first widget. A plurality of other widgets is displayed on a second tier on the display device. The media digital assets associated with the plurality of other widgets on the second tier are manipulable by the user such that, upon manipulation by the user, a media digital asset associated with a widget on the second tier is directly presented to the user.

As another illustration, systems and methods can be configured to receive search input from a user for searching a plurality of media digital assets stored in a data store. Metadata is associated with the media digital assets. The metadata associated with the media digital assets is used to determine an asset's relevance with respect to the received search input. The media digital assets are ranked based upon the determined assets' relevance. Media digital assets are retrieved from the data store based upon the ranking of the media digital assets. The retrieved media digital assets are automatically displayed on a display device.

As yet another non-limiting example, methods and systems can be configured for providing access to media digital assets through a web site. A media digital asset is received from a user over a communications network. The media digital asset is a proprietary asset of the user. The user has an agreement with respect to the media digital asset so that the received media digital asset is exclusively available through the web site. The user is a member of a group focused on a predetermined interest. The interest has been identified as an interest for which media digital assets are being generated or have been generated by people associated with the interest. It is determined whether to allow access of the received media digital asset to select members within the group or to publish the received media digital asset to the group. The media digital asset is stored with other assets within a data store. Access is provided to the group to the received media digital asset in accordance with the determined access rights.

As yet another non-limiting example, methods and systems can be configured for providing access to media digital assets through a web site. A media digital asset is received from a user over a communications network. The user (acting on behalf of a third party who owns the content) has an agreement (e.g., exclusive license, co-ownership agreement, etc.) with respect to the media digital asset so that the received media digital asset is exclusively available through the web site. It is determined whether to allow access of the received media digital asset to select members within the group or to publish the received media digital asset to the group. The media digital asset is stored with other assets within a data store. Access is provided to the group to the received media digital asset in accordance with the determined access rights.

### BRIEF DESCRIPTION OF THE DRAWINGS

FIG. 1 is a block diagram depicting an environment for accessing digital media assets.

FIG. 2 is a block diagram depicting a user interface generation software system and asset searching software system.

FIG. 3 is a block diagram depicting various assets that are associated with metadata.

FIG. 4 is a block diagram depicting a user interface generation system determining an asset tiering display arrangement.

FIG. 5 is a block diagram depicting a two-tier display arrangement.

FIG. 6 is a block diagram depicting an additional tiering display arrangement.

FIG. 7 is a block diagram depicting a tiering display arrangement with associated indicators.

FIGS. 8A and 8B are user interfaces illustrating a tiered arrangement.

FIG. 9 depicts visual indicators that can be used in a sports-related context.

FIG. 10A and 10B are user interfaces illustrating another tiered arrangement.

FIGS. 11A-11CC depict examples of different user interface configurations.

FIG. 12 is a block diagram depicting selection of assets for display based upon their relatedness to a first tier asset.

FIG. 13 depicts examples of metadata tagging for different data items.

FIGS. 14-16 are flow diagrams for selecting items for display.

FIG. 17 is an example metadata structure diagram.

FIG. 18 is an example of an advertising selection process.

FIGS. 19-22 illustrate different social networking aspects related to an asset access system.

### DETAILED DESCRIPTION

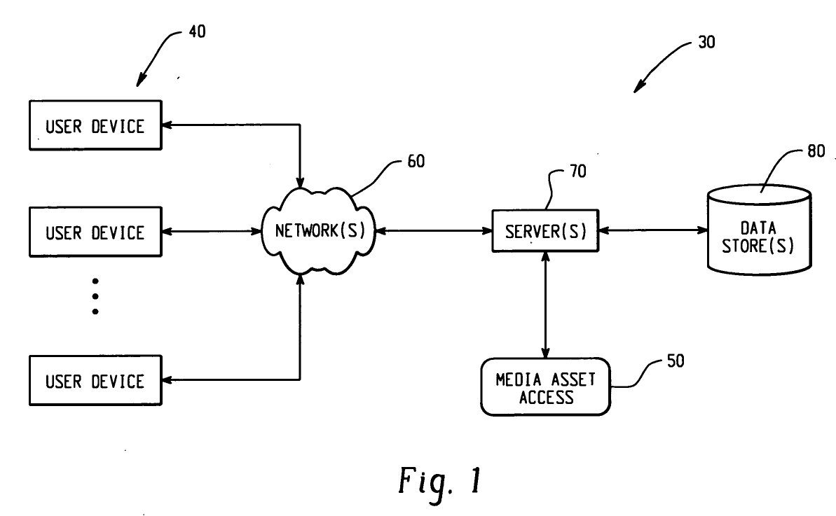

FIG. 1 depicts at 30 an environment wherein user devices 40 or platforms interact with a software system 50 for accessing digital media assets. The digital media assets may assume many different forms, such as video, audio (e.g., music), images, graphics, text, etc. The user devices 40 can interact with the access system 50 through a number of ways, such as over one or more networks 60. Server(s) 70 accessible through the network(s) 60 can host the software system 50 for accessing digital media assets. It should be understood that the media asset access system 50 could also be provided on a stand-alone computer for access by a user.

The media asset access system 50 can be an integrated web-based tool that provides users with flexibility and functionality for accessing the digital media assets. User devices 40 (other than computer or laptop devices) can be used, such as mobile communication devices, gaming devices (e.g., Sony Playstation®), etc. Data store(s) 80 accessible via the server(s) 70 provide storage for the digital media assets and the information needed to locate the assets. The data store(s) 80 for the digital media assets may be located on the same or different servers 70 as the data store(s) 80 that store the information needed to locate the assets. Similarly, the different routines or programs of a media asset access system 50 may be located on the same server or distributed on multiple servers depending upon the situation at hand.

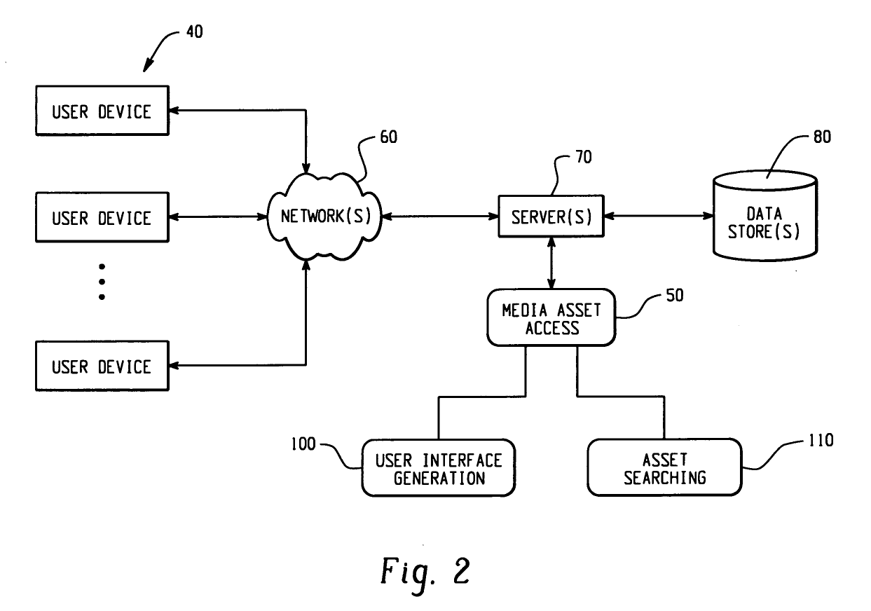

FIG. 2 illustrates that the media asset access system 50 includes a user interface generation software system 100 and/or asset searching software system 110. The user interface generation software system 100 is configured to automatically display media assets as tiers of interface items or widgets on a display device, where the tiers provide varying degrees of information (e.g., a first tier provides the most information, second tier less information, etc.). A “widget” can be considered a visual representation of a media data piece and can be an autonomous capsule of information that exists on the site in a free-floating, multi-dimensional way.

Through the user interface generation software system 100, a first widget is displayed on a first tier on a user display device. Other widgets are displayed on one or more additional tiers on the display device. The tiered display arrangement of media assets allows for multi-media content to be viewed in a user-friendly and intuitive way.

The asset searching software system 110 provides the users with a powerful searching mechanism for locating the media assets of most interest and relevance to the users. For example, the asset searching software system 110 can be configured to receive search input from a user for searching a plurality of media digital assets stored in a data store. The software system 110 determines an asset's relevance with respect to the received search input. Based upon the assets' determined relevance, media digital assets are retrieved from the data store and displayed on a user's display device.

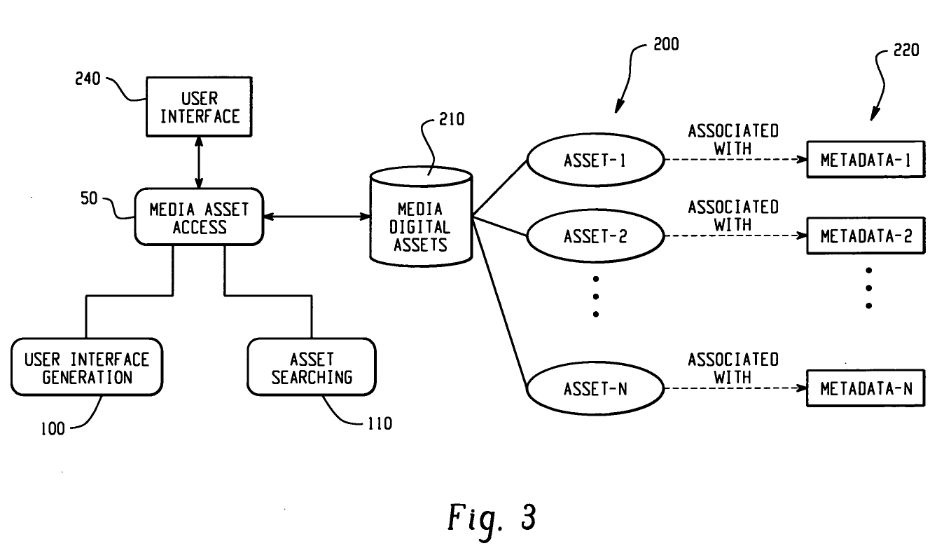

FIG. 3 illustrates that the various assets 200 that are stored in a media digital assets data store 210 are associated with metadata 220. The metadata 220 provides a description of the assets 200 so that the operations of the media asset access system 50 can be performed. As an example of metadata, metadata can include what type of asset it is and to what category or categories an asset is related.

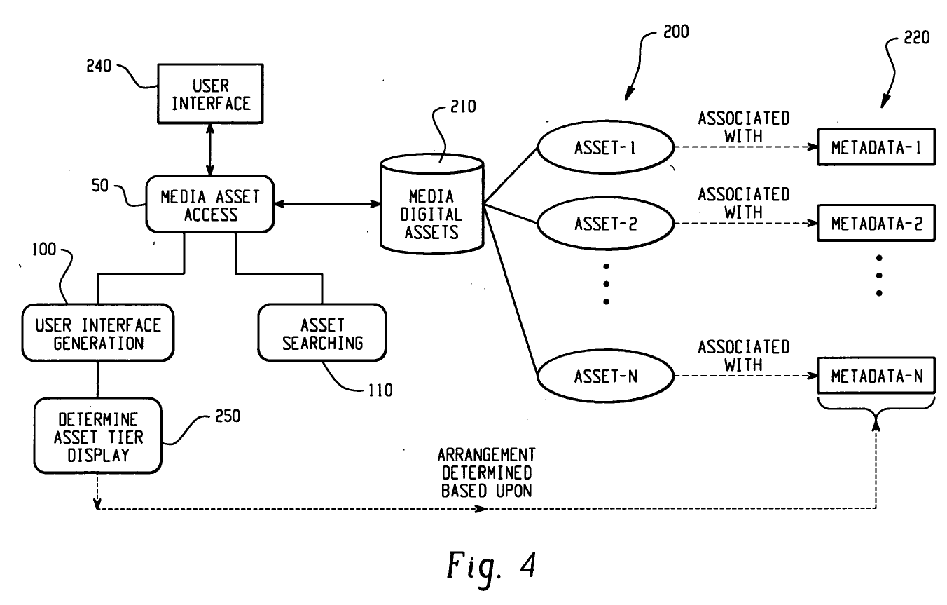

FIG. 4 illustrates that the user interface generation system 100 determines via processing 250 its asset tiering display arrangement based upon the metadata that is associated with an asset. Each individual item (e.g., video clip, still photo, magazine article, equipment review, etc.) is metatagged. Each item is categorized and ranked for its relevance versus a list of criteria. This system of metatagging allows the website to display on a user interface 240 the most pertinent and interesting information to the user.

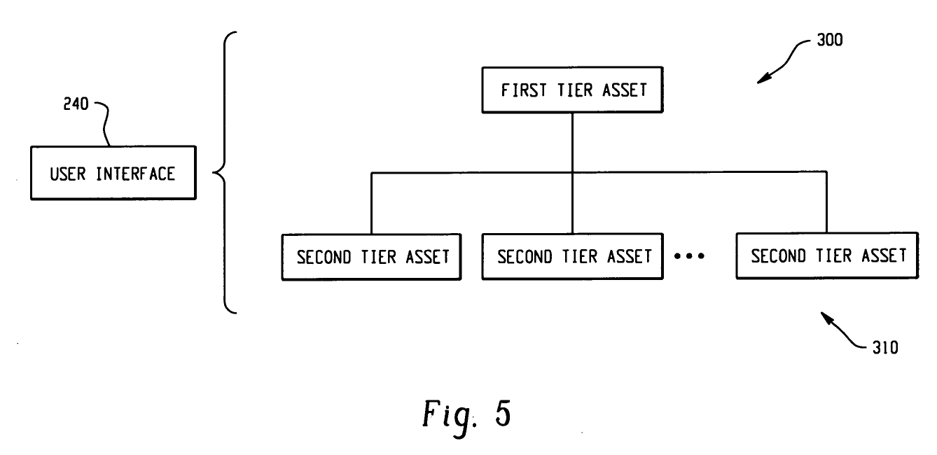

FIG. 5 shows a two-tier display arrangement (300, 310) for a user interface. The user interface 240 displays a media asset in the first tier 300. Assets which are deemed most relevant or related to the first tier asset are displayed in the second tier 310.

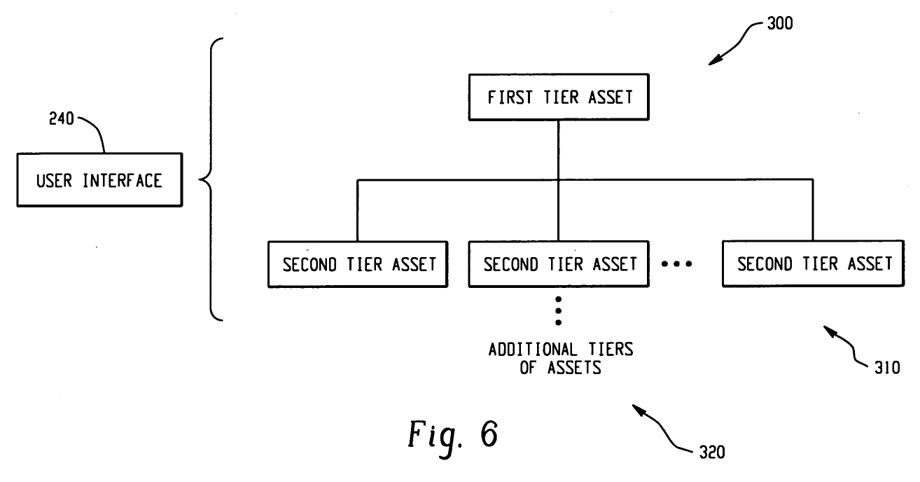

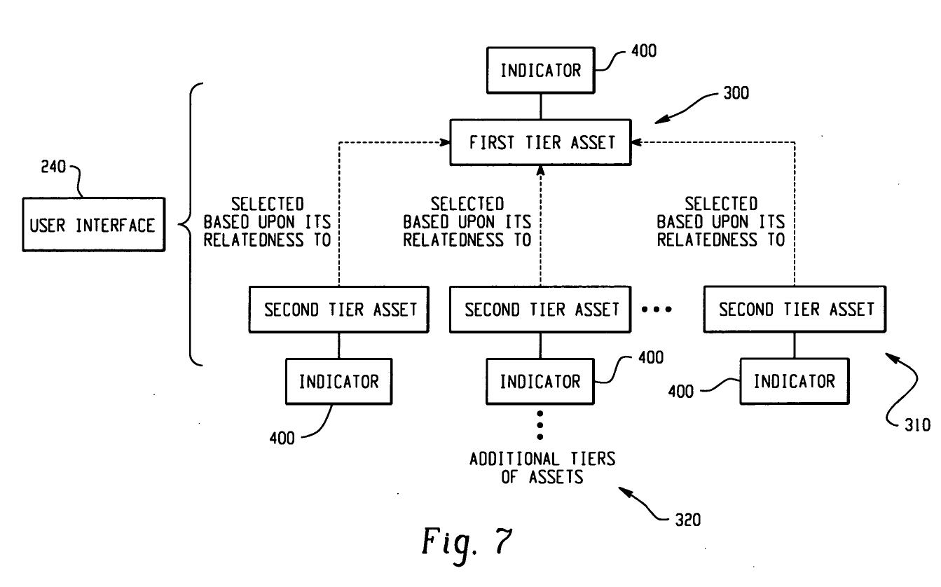

Additional tiers 320 of assets may also be displayed on the user interface 240 as shown in FIG. 6. The additional tiers 320 (e.g., a third tier of assets) can hold assets that are most relevant or related to one or more assets that occupy the second tier 310. It should be understood that the tier arrangement does not have to be hierarchical in nature, but can assume many different configurations and dimensions that indicate which asset is associated with a first tier and which assets are associated with other tiers. For example, a first tier asset can have a visual characteristic that indicates that the asset is a first tier asset. One or more visual characteristics can be used to provide such indication, such as size, color, screen position, etc. This is illustrated in FIG. 7 wherein an indicator 400 is associated with a displayed asset. The indicator 400 conveys immediate information to the user about the nature and tier of the displayed asset.

The widgets populate on the user interface 240 as a result of a user search. It should be understood that a search can include any action performed by the user that results in a display of the media assets. The widgets populate the user interface 240 in different tiers as represented, e.g., by the size of the widgets. As an illustration, the size of a tertiary tier widget would be small, the size of a secondary tier widget would be medium, and the size of the primary tier widget would be large.

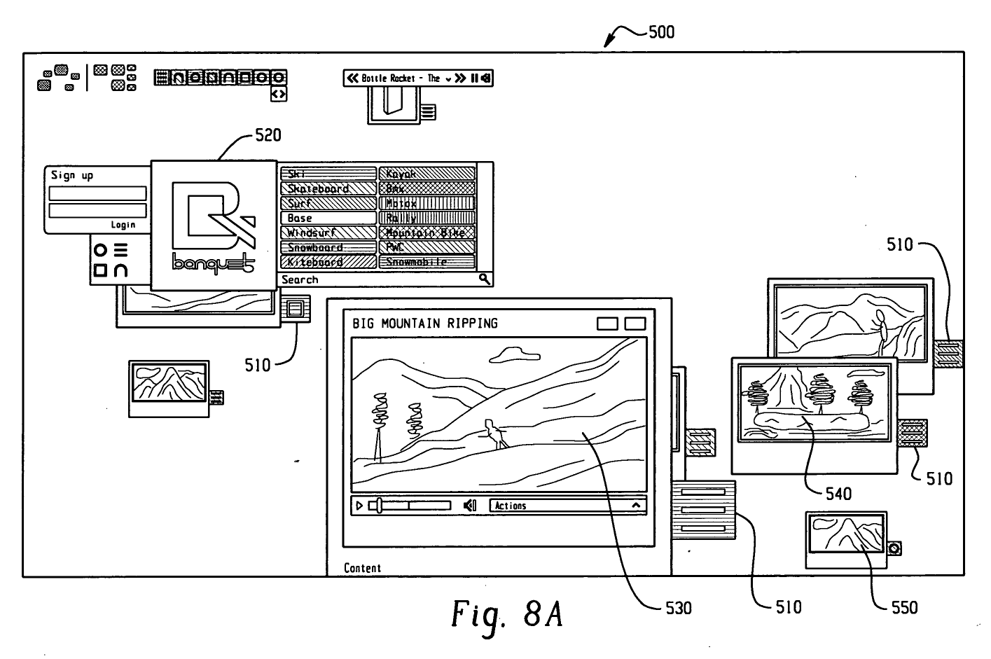

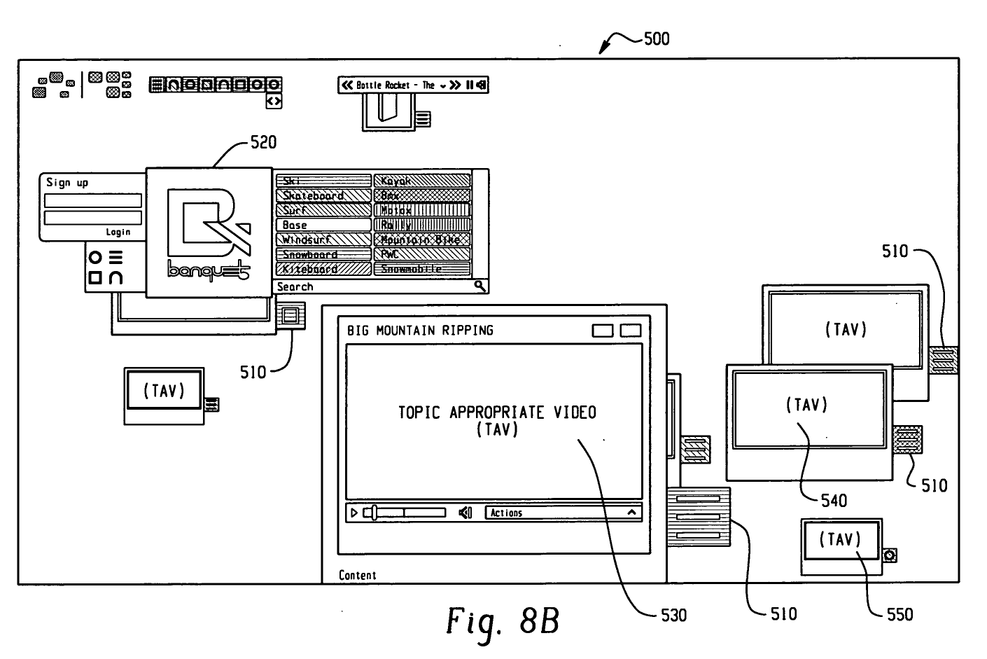

FIG. 8A provides at 500 an example of a user interface having a tiered arrangement as well as visual indicators 510 to identify the nature and other information associated with a displayed asset (FIG. 8B is a generalized depiction of FIG. 8A). The tiering arrangement and visual indicators allow efficient navigation of web sites that have a great amount of information (e.g., media assets) that is constantly in flux.

The user interface in the example of FIG. 8A operates on different levels:

1. Remote control and user profile

2. First tier

3. Second tier

4. Third tier

5. Advertiser's tier

The remote control 520 is the user profile or page in a “closed” state and conversely the user profile is the remote in an “open” state. The remote provides navigational tools the user is familiar with from other sites and is the connection to the site. The remote is fully customizable when the user “opens” it to the user profile. The user profile is the conduit and the repository of the user. From this platform the user is able to publish their own contributions into the site, upload other content just to their page, pull content from the site and store it and customize the navigation and experience of the site.

The first tier widget 530 is relatively large and designed for media to be viewed and give a sample of any text that is included. The first tier widget contains a tool bar to control the media in addition to having a drop down menu that allows the user chose their actions. As an example of an action, a viewer can purchase the long-form digital version of what they saw or send it to their mobile phone or download it to their iPod all in one click. When the user creates a user profile they enter their device and credit card information, which allows the purchase and distribution of content to be fast and easy. Widgets can be configured to be dragged-and-dropped (e.g., from a desktop to the site's webpage) into the user profile and then automatically sorted into the appropriate Favorites area.

The second tier widgets (e.g., widget 540) is visually smaller than a first tier widget, but larger than a third tier widget (e.g., widget 550). Second tier functionality is configured to provide the user with a preview of the content contained within it. When the second tier is not engaged by the user it displays a static image from or indicative of the content. When the user rolls their cursor over the widget a Flash loop preview of a predetermined duration (e.g., ten seconds) will play, and in addition a small text balloon will pop up to provide the title and a brief description about the content. When the second tier widget(s) is/are not engaged they begin to dynamically group themselves by like meta tagged information. The second tier widgets can also be displayed such that the user is able to focus more readily on the primary widget without undue distraction by the other tier widgets. For example, the second tier widgets can be displayed in a smaller size and slightly out of focus.

The third tier contains the smallest widgets. Its primary functionality is to display a small static image of the content. When the user rolls their cursor over a third tier widget, a small text balloon (that is smaller than a second tier widget) pops up giving the user the title of the content. These widgets also move in a dynamic way, reorganizing themselves into like groups.

The distance between a widget to the next tier widget is indicative of the level of relatedness between them (e.g., the closer one widget is to another, the stronger their interrelation is). The system can be configured such that any widget on any tier can be activated (e.g., clicked upon) which will bring it to the primary position. From the primary position the user can chose to expand it to a primary expanded state from which they will be able access all tools specific to the medium (e.g., actions for video content can include play, stop, actions for a slide show can include click through one by one, etc.). From the primary expanded mode the user can also choose how they would like to distribute the content, such as to send it to another device (e.g., an iPod, mobile phone, PSP, a friend, post to another web site, etc.). When a widget is accessed from any tier it constitutes a search in the system and the widgets that are returned from the search are displayed on the user interface's canvas.

As another dimension (e.g., tier or level) that can be part of the display to the user, the display of an advertising tier can be considered as an additional level of information and can be configured to consume the entire or partial background of the display. The advertiser's display may be the wallpaper on their desktop. The other tier widgets contain metatagged advertising information, so that when a widget is activated, the advertising tier interface item changes according to the meta information. In this way a site can sell customized advertising space on the site as percentages, or by interest (e.g., sport) or even by type of content. This provides advertisers flexibility in terms of reaching the exact portion of the audience they are interested in. However, it should be understood that advertising can be handled in many different ways, such as a fourth tier widget can contain a brand logo and other tier widgets may also be affected with advertising. As an illustration other brand collateral such as branded content, gear reviews and anything contained within the site's archives can be pulled up and presented in second and third tier widget forms with the other pieces of content that directly relates to the user's selection.

This can be used as a way to control and organize the content as a company sees fit. For example, it can allow the company to “push” certain pieces of content to the top level, thereby allowing enormous flexibility in terms of designating “levels” of content—that is, a company can support their advertisers, particular content providers, etc. by making their content the “top level” or featured content.

As mentioned above, many different types of media assets may be simultaneously displayed on the user interface. As an illustration, a first tier widget can contain video content while a second tier widget contains text information about a product that appears in the video content of the first tier widget. Accordingly with the tiered arrangement, the user interface display approach of FIG. 8A allows for intuitive information organization, instant access to similar information in disparate medium, customized user experience and preferences, as well as the ability to navigate quickly via visual identification (e.g., visual indicators).

It should be understood that a user interface generation display system does not have to utilize all the features that are shown in FIG. 8A, but rather may include only one or more of the interface features shown in FIG. 8A. For example, the tiering arrangement may be used separately from or together with the other interface features shown in FIG. 8A, as well as utilized with additional features. As an illustration, the tiering arrangement can be used in combination with a criteria that determines the population of widgets on the canvas of the interface. Different types of criteria can be used, such as establishing a set number of widgets that can populate the canvas at one time (e.g., one primary, three secondary and six tertiary). The number may also be based upon the user interface screen display. For example, the set number of widgets to be displayed for a relatively large flat screen display device can be configured to be higher than the set number of widgets which are to be displayed for a cell phone with a relatively small screen size.

Visual indicators 510 associated with the displayed tiered widgets allow a user to identify the nature of the displayed asset even though the displayed asset may not be entirely visible to the user. This may occur when an asset occupies a lower tier and thus its size may be too small for a user to fully recognize the nature of the asset. It should be understood that visual indicators may be associated with many different types of interface items in order to indicate what data occupies a given widget. For example, a tag can be used to indicate that a widget is associated with a professional athlete.

Many different types of visual indicators can be used with the user interface display depending upon the situation at hand. The visual indicators can include symbols and colors associated with the symbols to visually communicate two or more pieces of information simultaneously to the user. The selection of visual indicators can allow the entire interface to be navigable by iconography. This not only allows for a more efficient user interface navigation mechanism, but also allows international users (e.g., users who might not be familiar with the language utilized on the website) to navigate the media asset content.

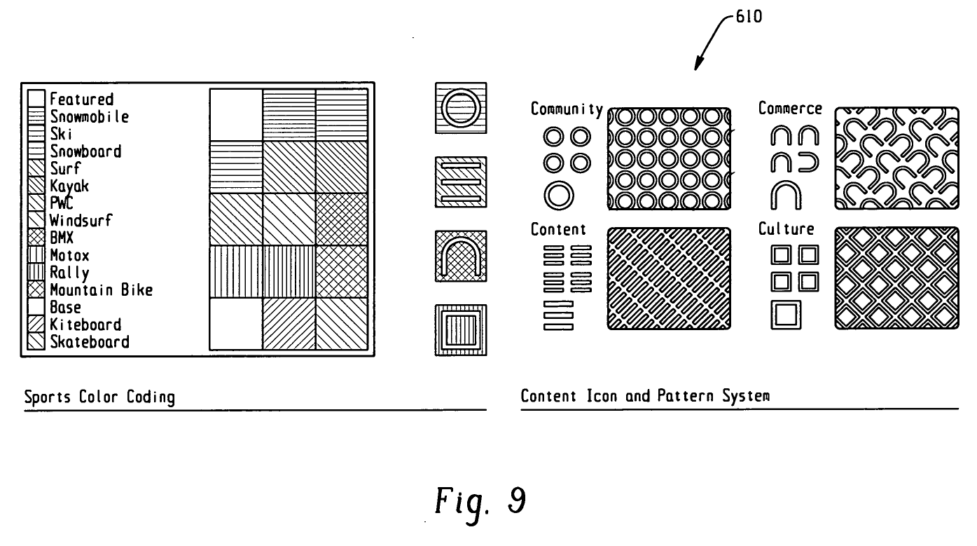

FIG. 9 provides an example of visual indicators that can be used in a sports-related context. Color represents at 600 the type of sport with which asset is associated and a symbol 610 represents a particular predefined category, such as community, content, commerce or culture. Icons can also be used to indicate the context of a widget. As non-limiting illustrations, a content icon can indicate a video asset (or other) is available. A culture icon can include still images and textual articles about a subject in which a user is interested (e.g., news articles, news photos, gear reviews, weather reports of locations related to a sporting activity, competitions, interviews, forums, calendar events, etc.). A community icon is associated with every person and includes personal information about that person, such as user likes and dislikes regarding a particular category of interest. It can also include who in the community website are the athletes, writers, photographers as well as other members who are most like a particular user. A commerce icon indicates that information is available to a user about products or services that are being offered for sale (e.g., DVDs for sale, top 10 list of products, gear reviews, etc.) For example a user may be viewing a video wherein an athlete is snowboarding. Information about the particular snowboard that the athlete is using and how the user can purchase the snowboard can be provided to the user. The user knows which interface item contains such information because it would be indicated by a commerce icon. The system may also provide other avenues for commerce to occur, such as providing action menu items with content-related widgets. In this manner, a user can perform commerce operations without having to necessarily go through a commerce-related widget.

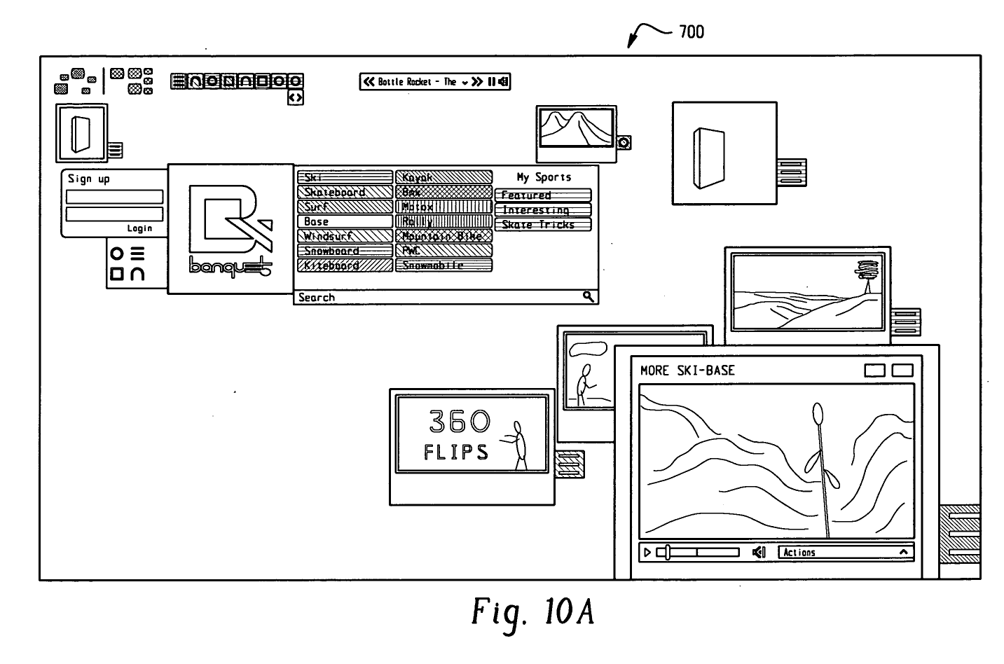

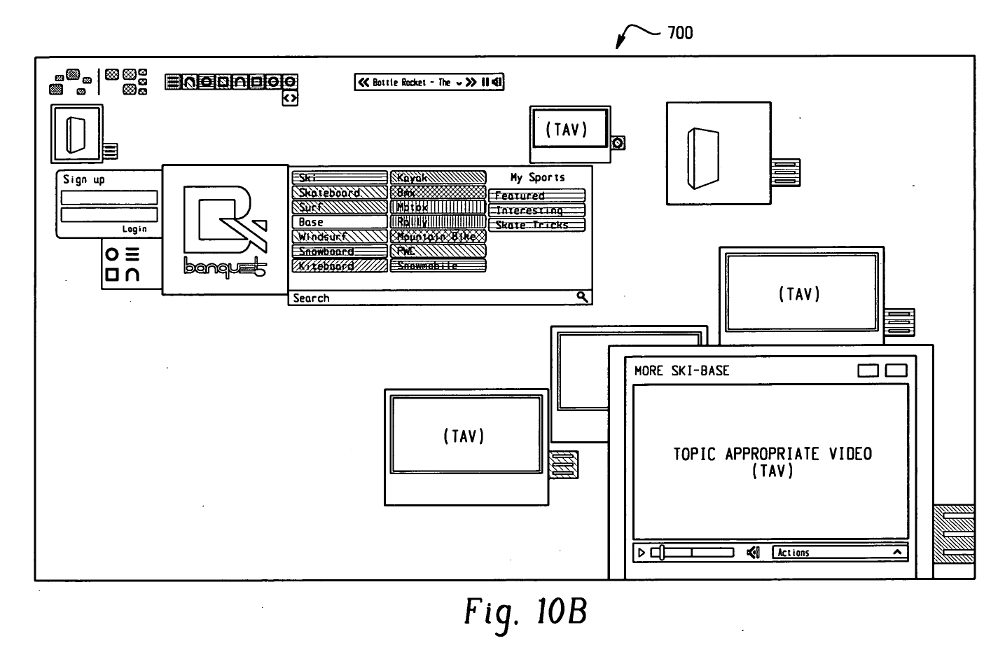

As shown at 700 in FIG. 10A, there are multiple colored icons that communicate directly to the user what area of interest each interface item is related to. (FIG. 10B is a generalized depiction of FIG. 10A.) FIG. 10A also illustrates that the larger widget when activated initiates a new search that has resulted in the display of one or more different media assets that were not present in the display of FIG. 8A. The digital assets are directly and seamlessly presented to a user without requiring the entire display of the display device to have be redisplayed or refreshed.

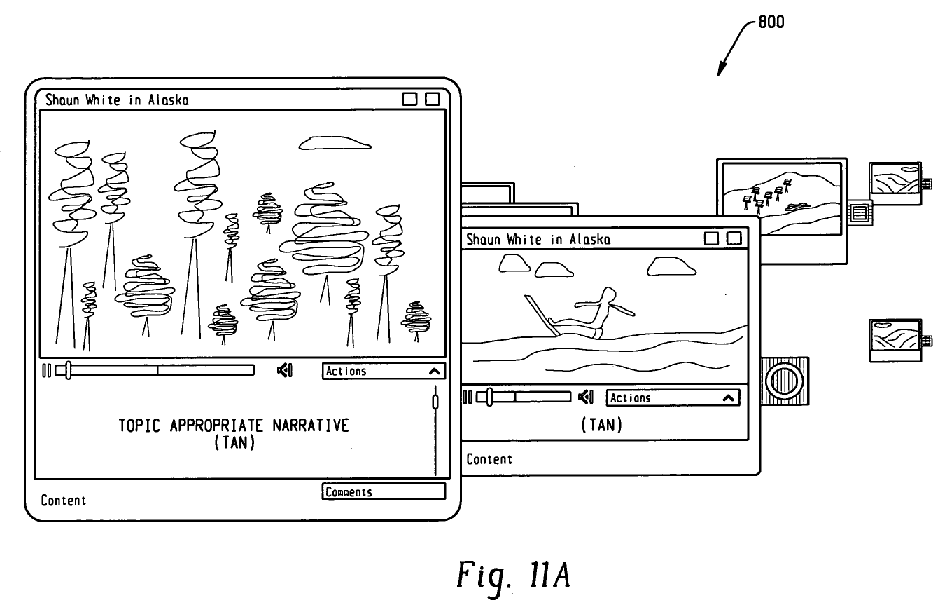

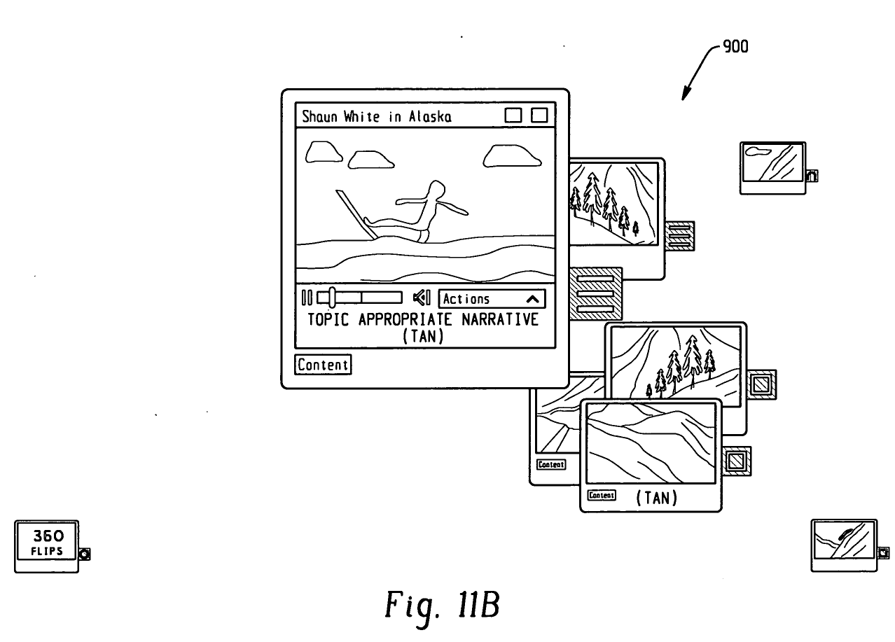

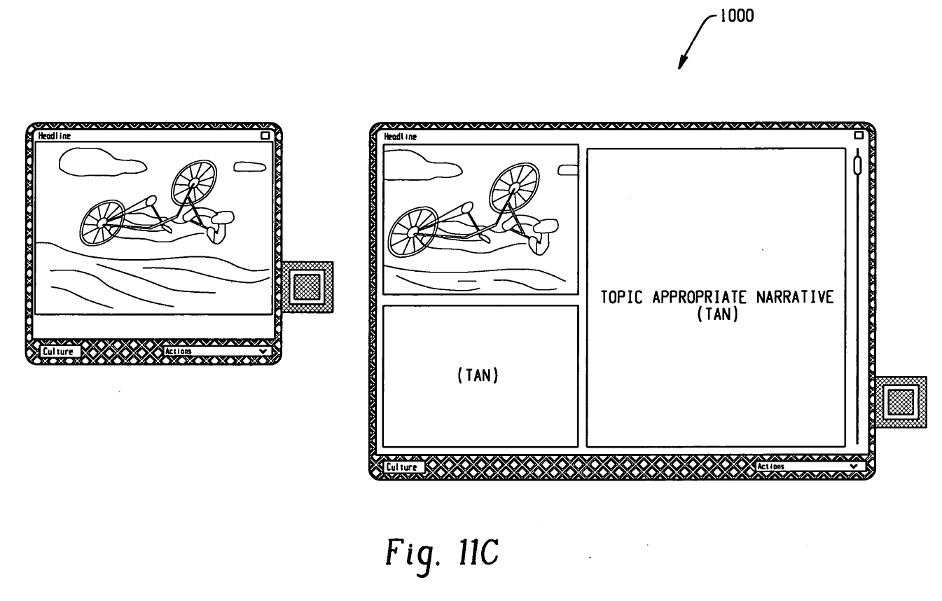

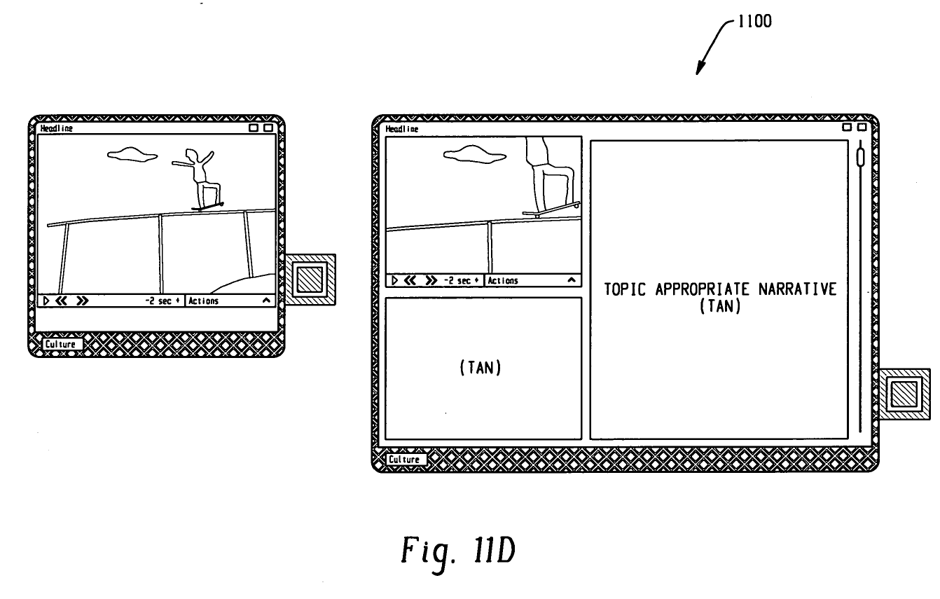

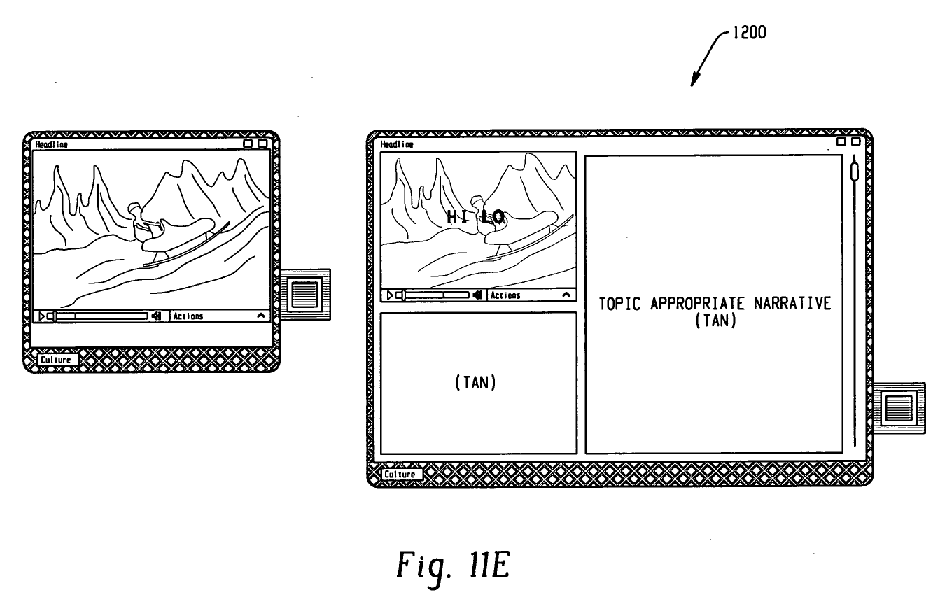

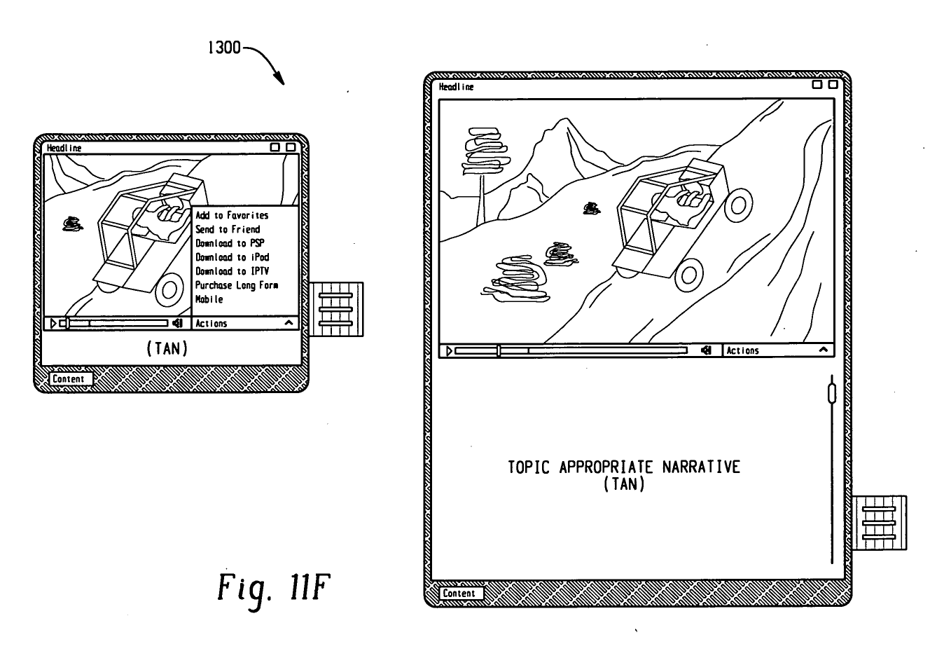

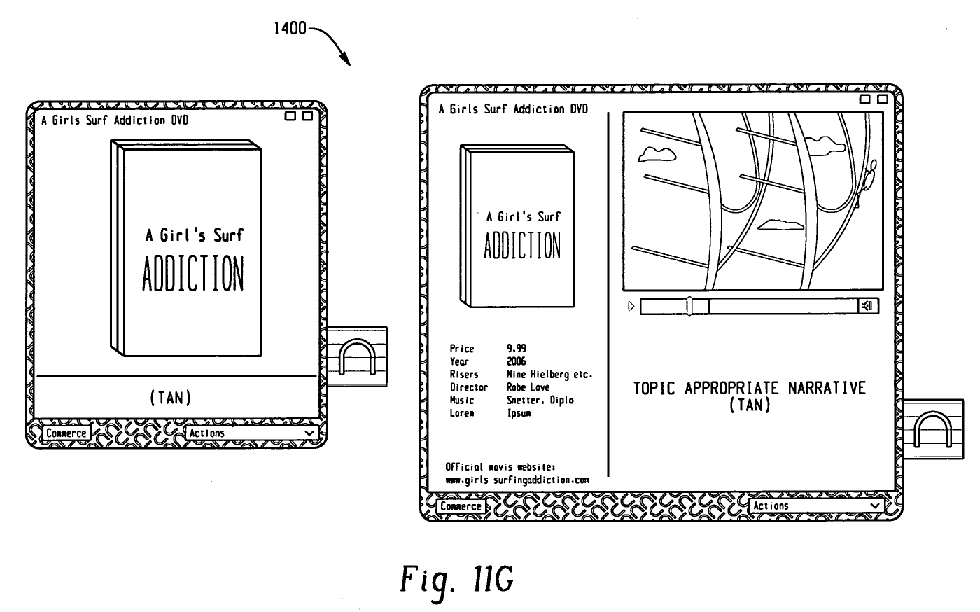

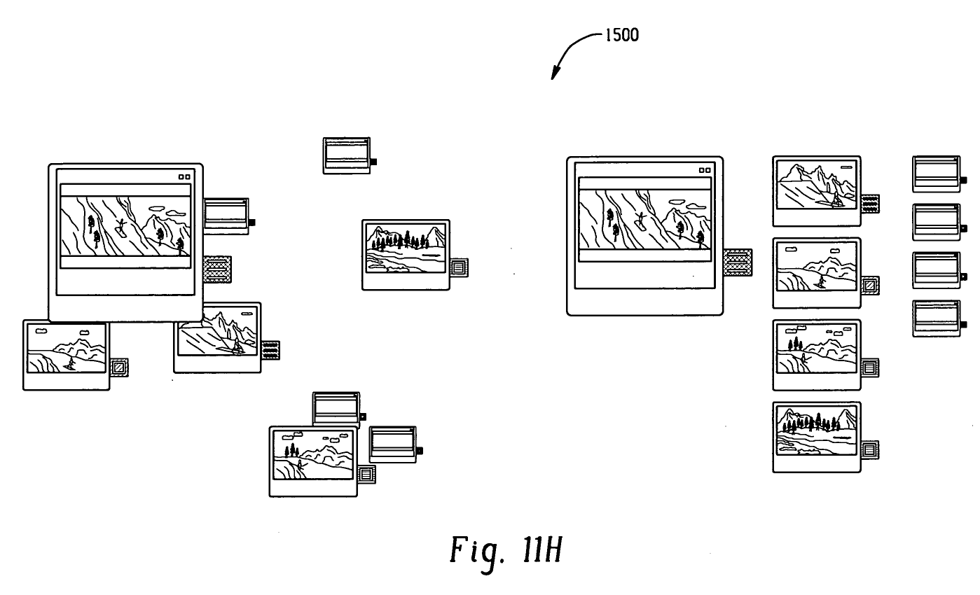

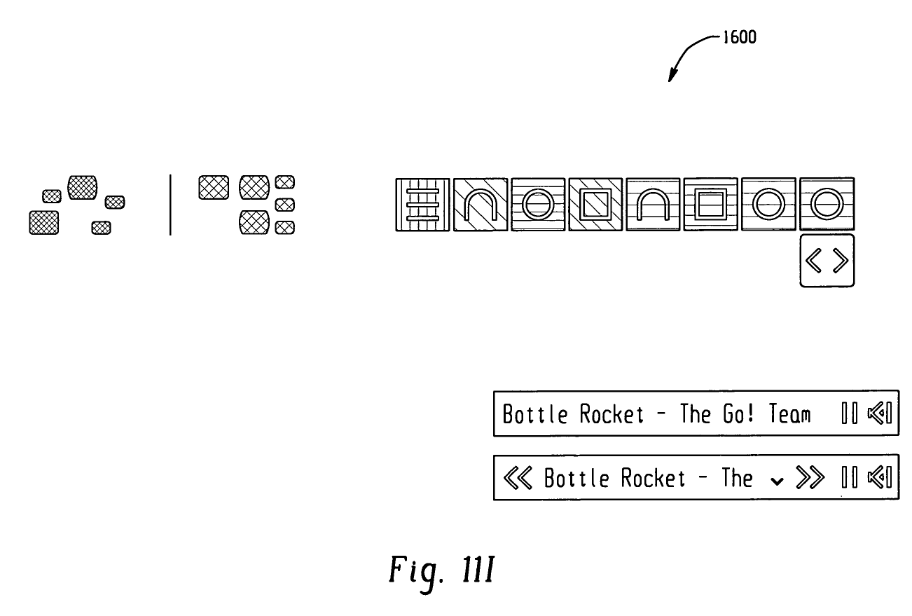

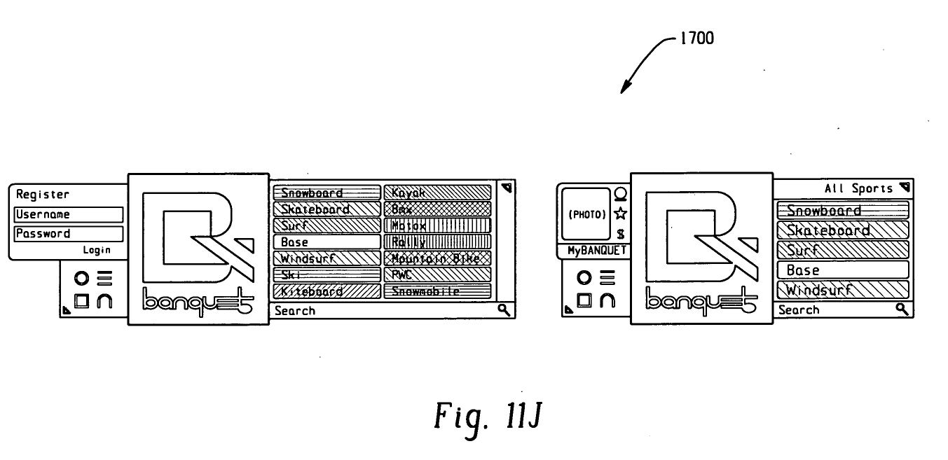

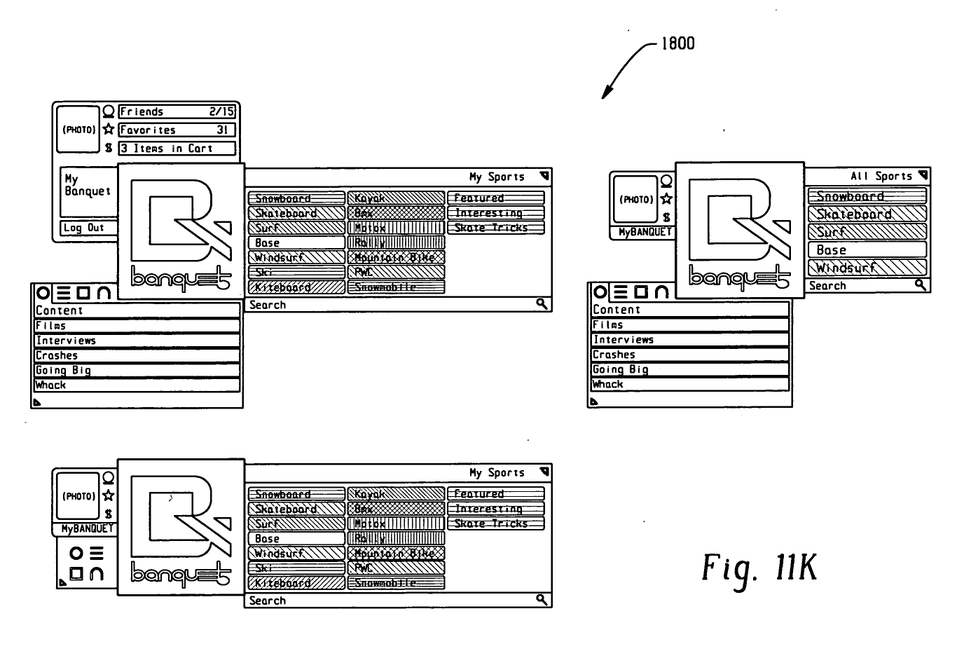

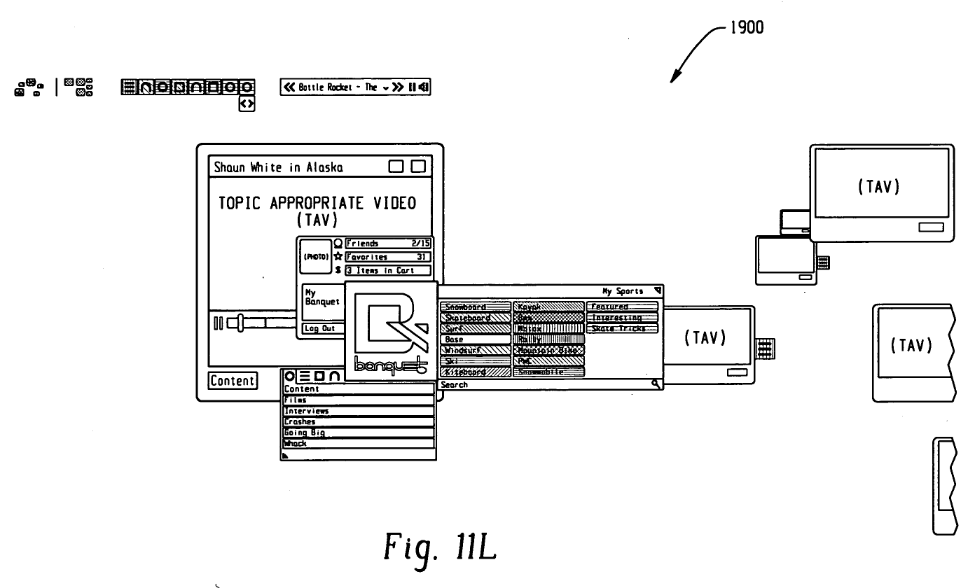

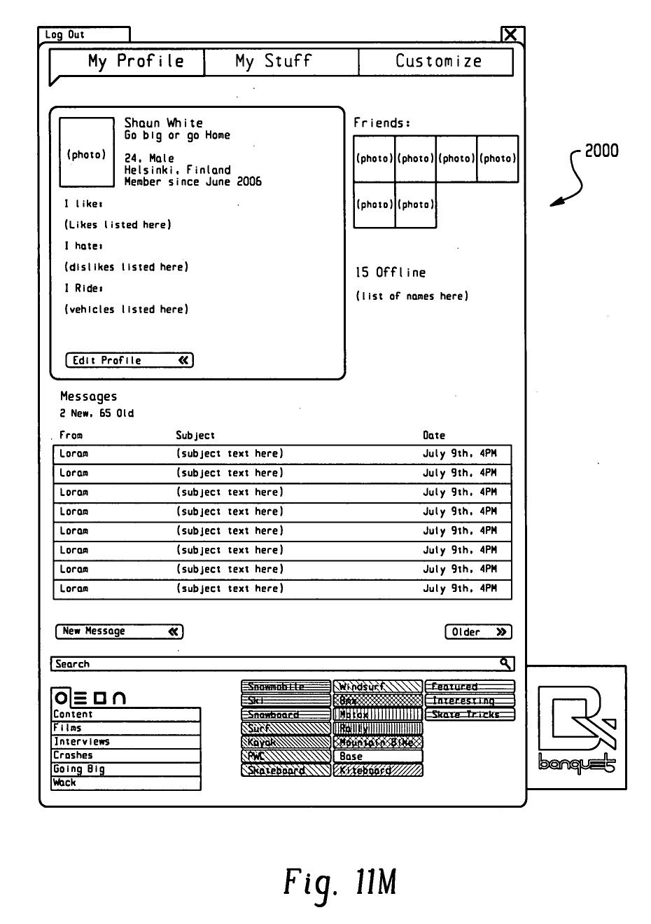

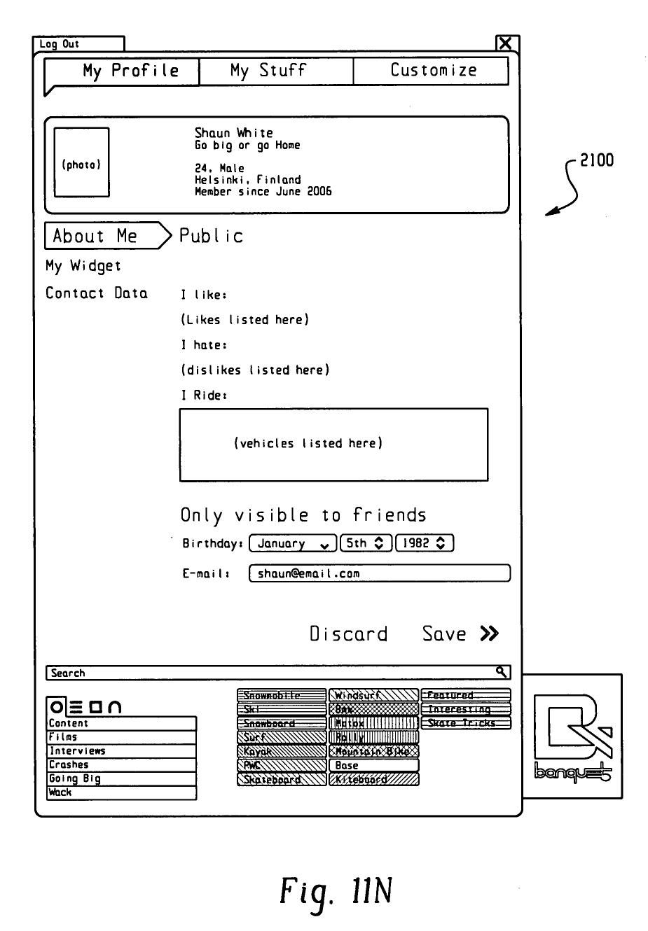

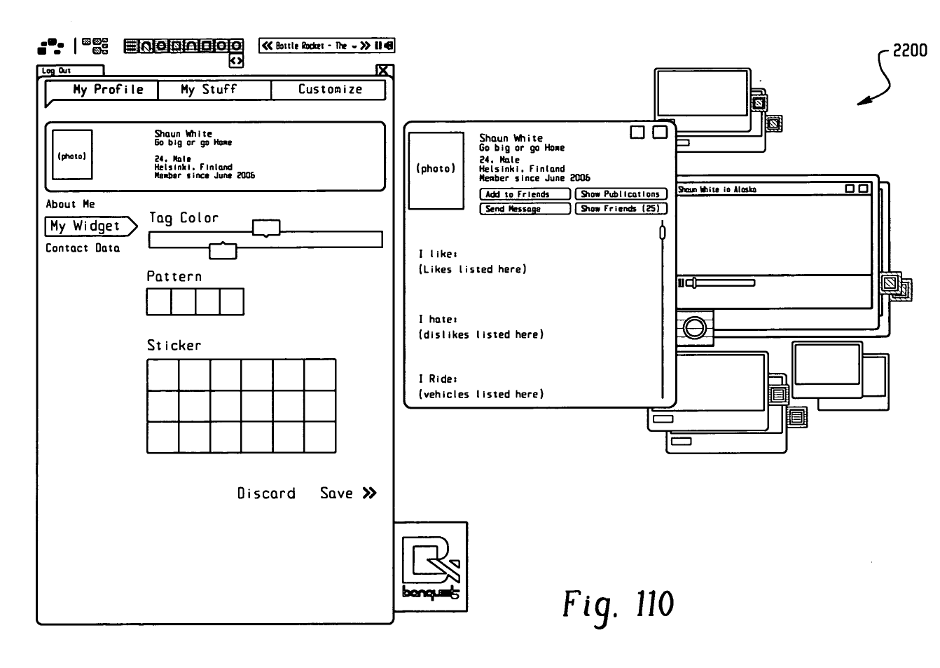

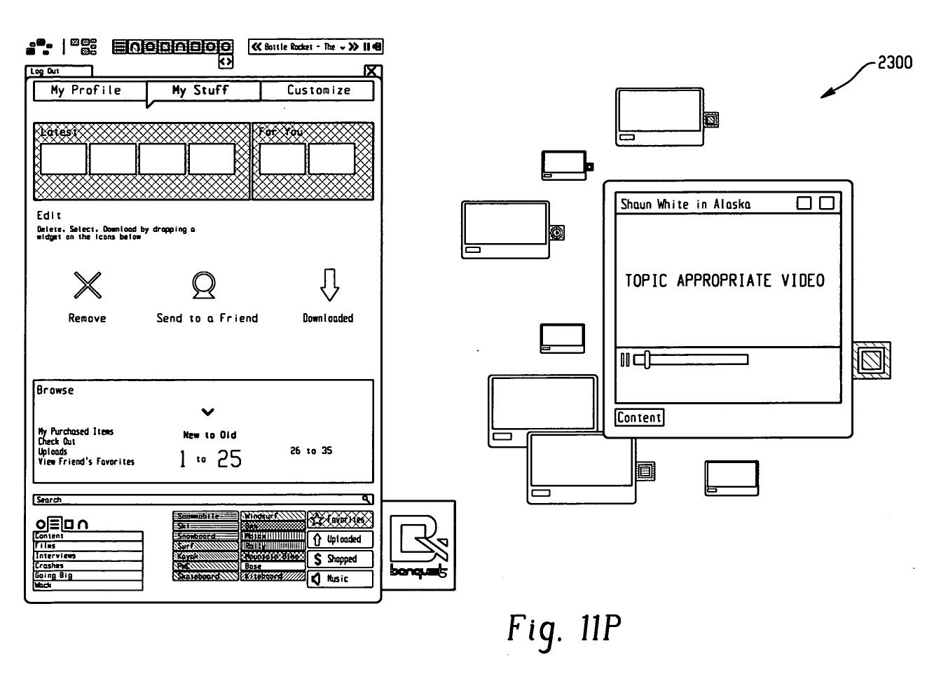

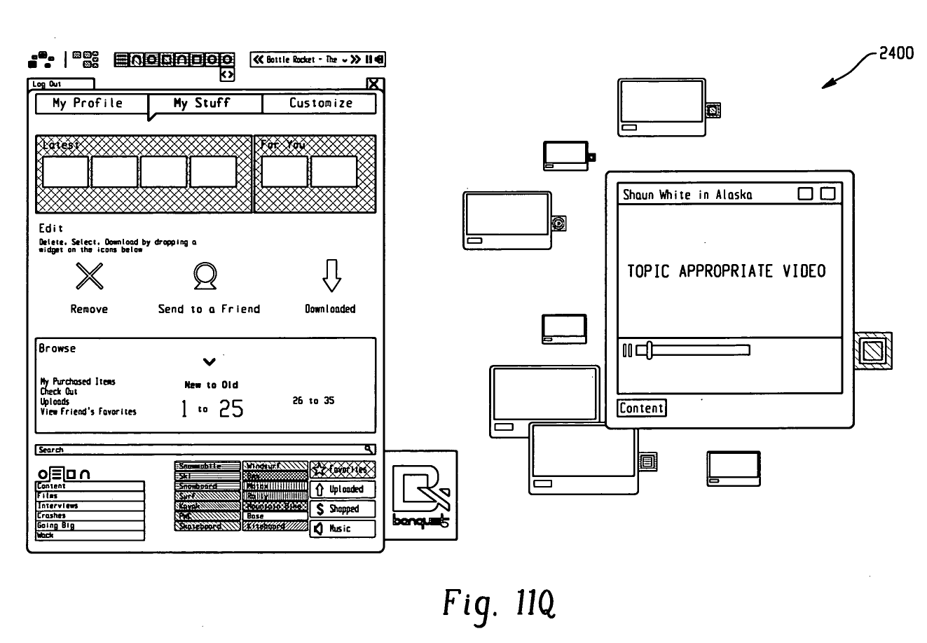

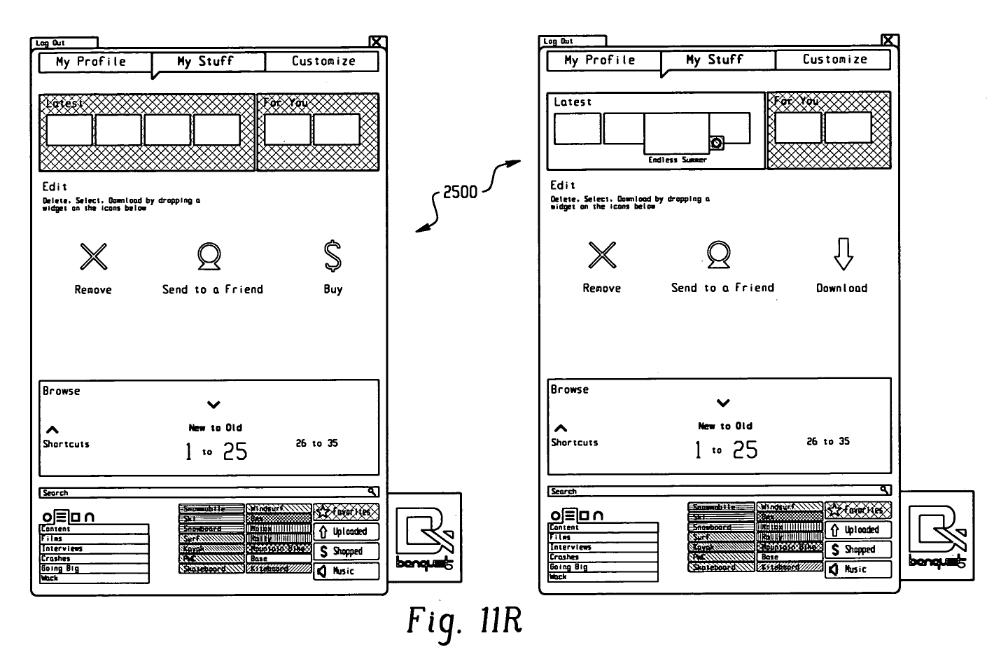

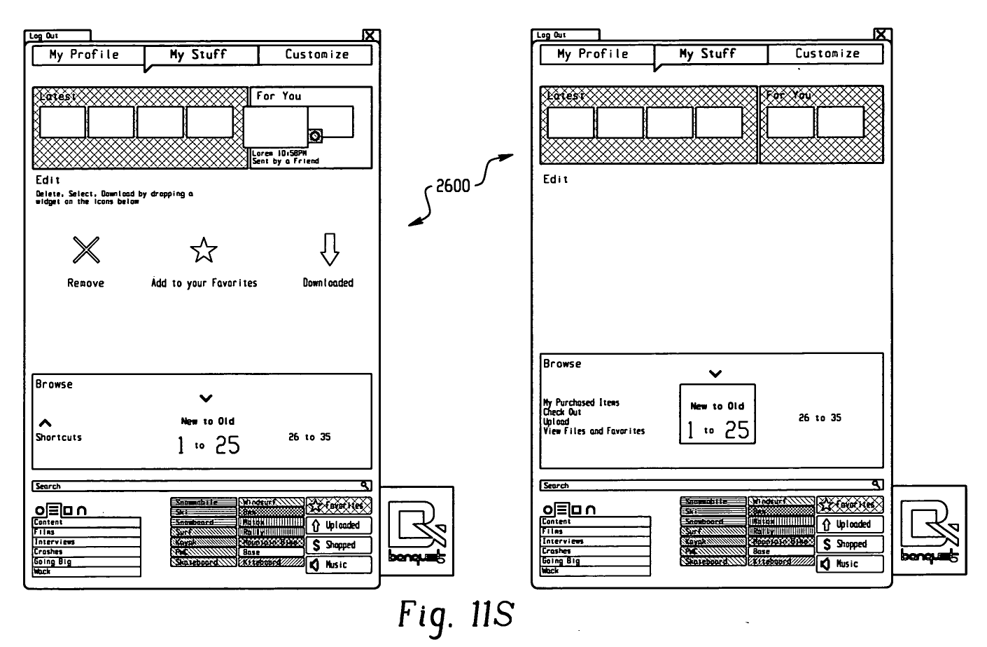

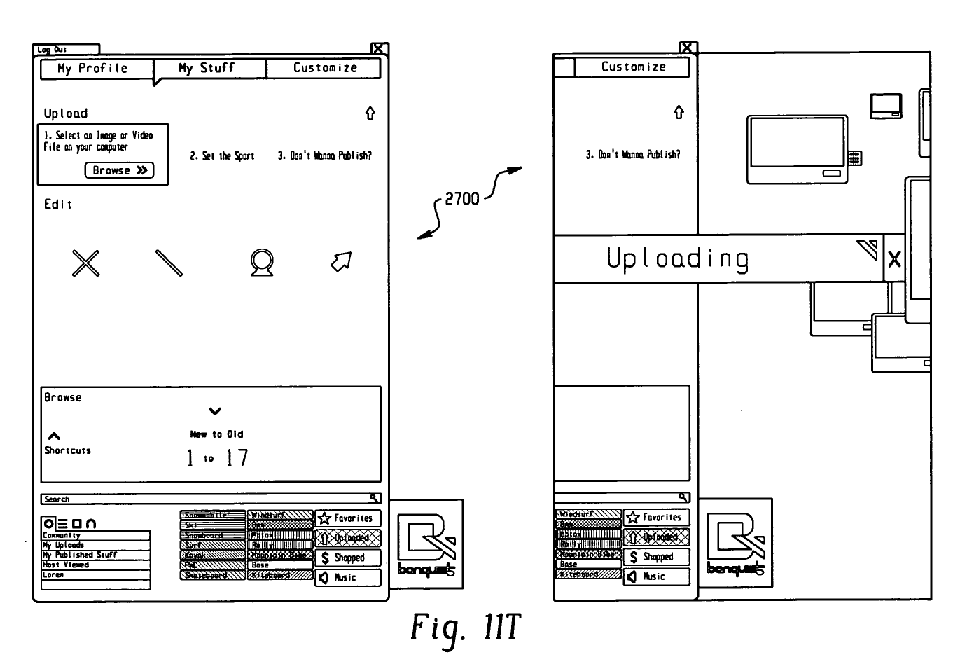

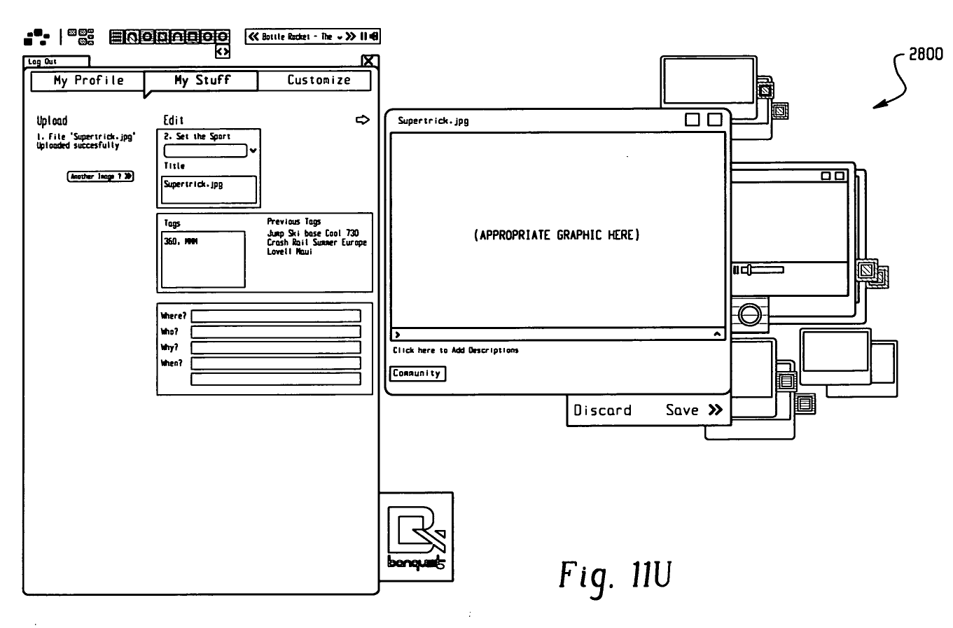

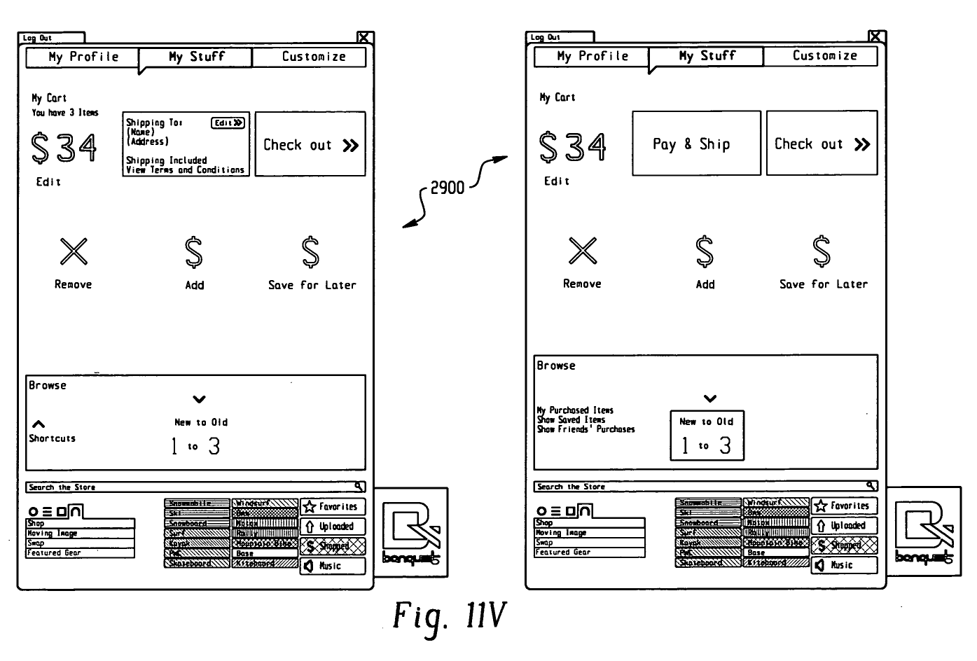

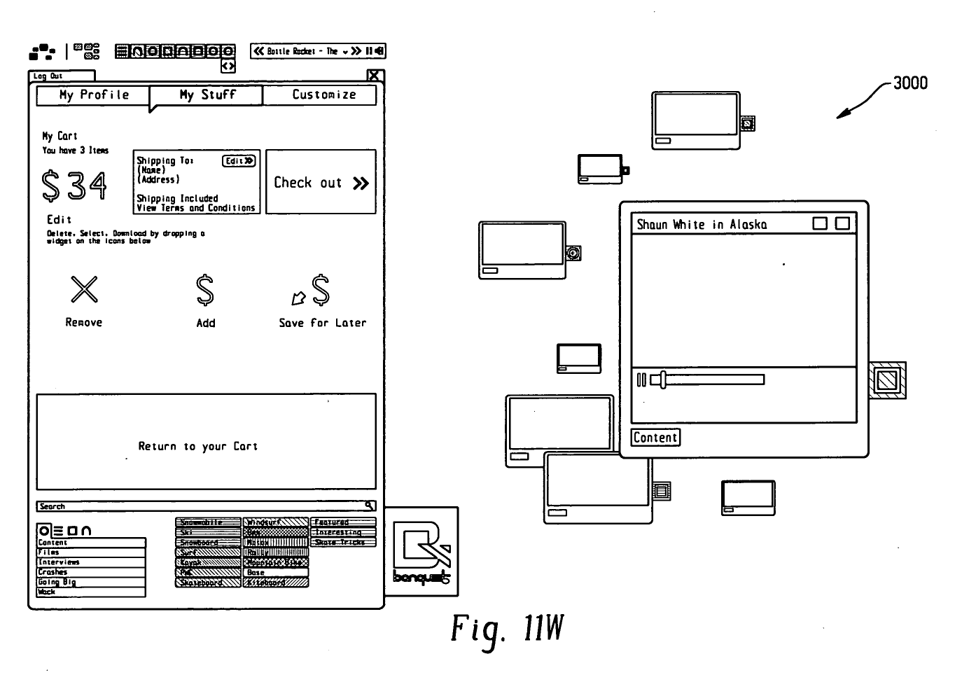

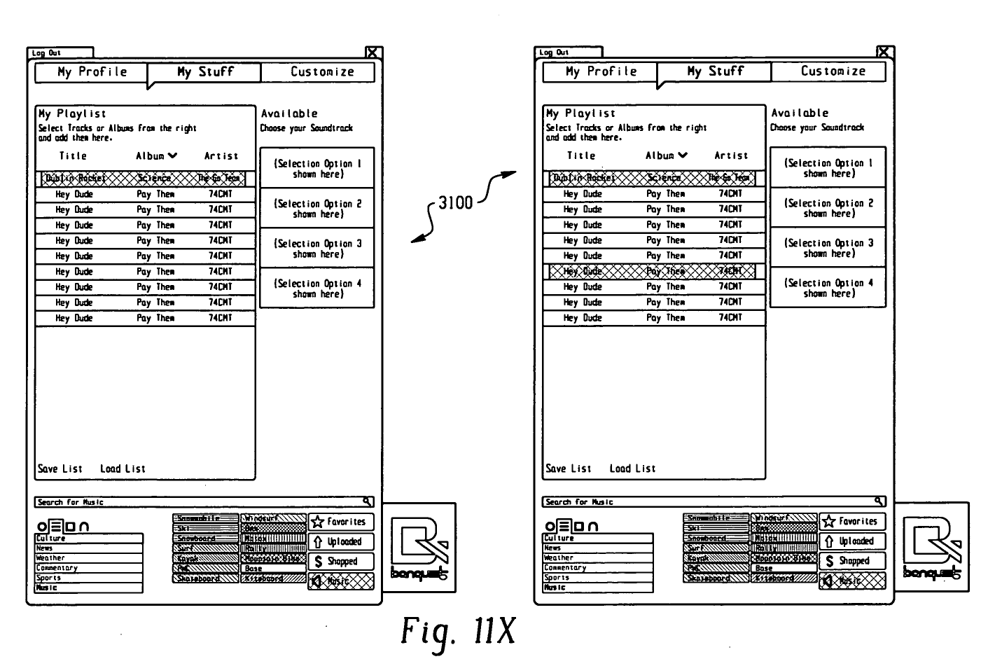

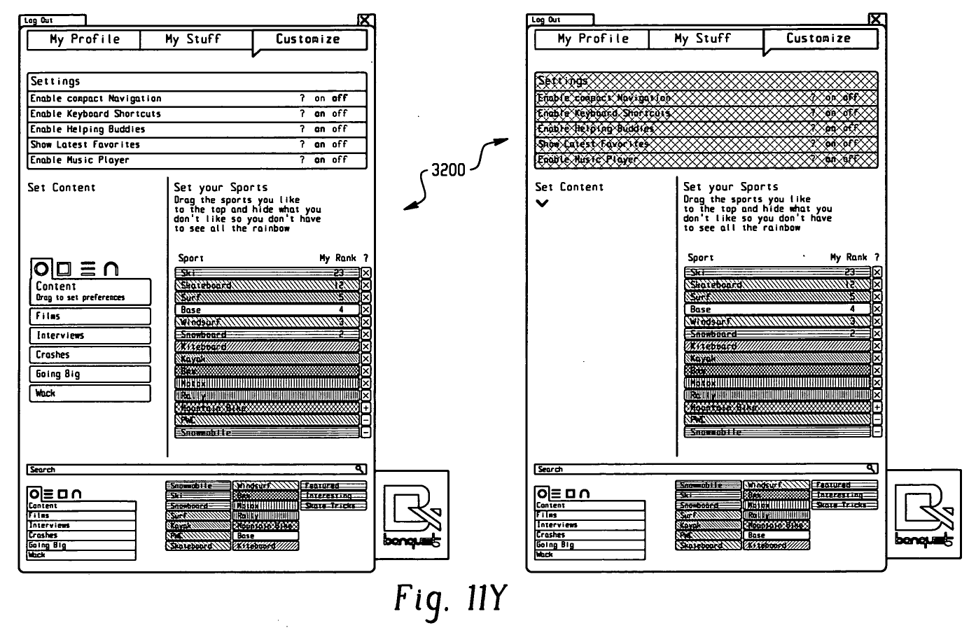

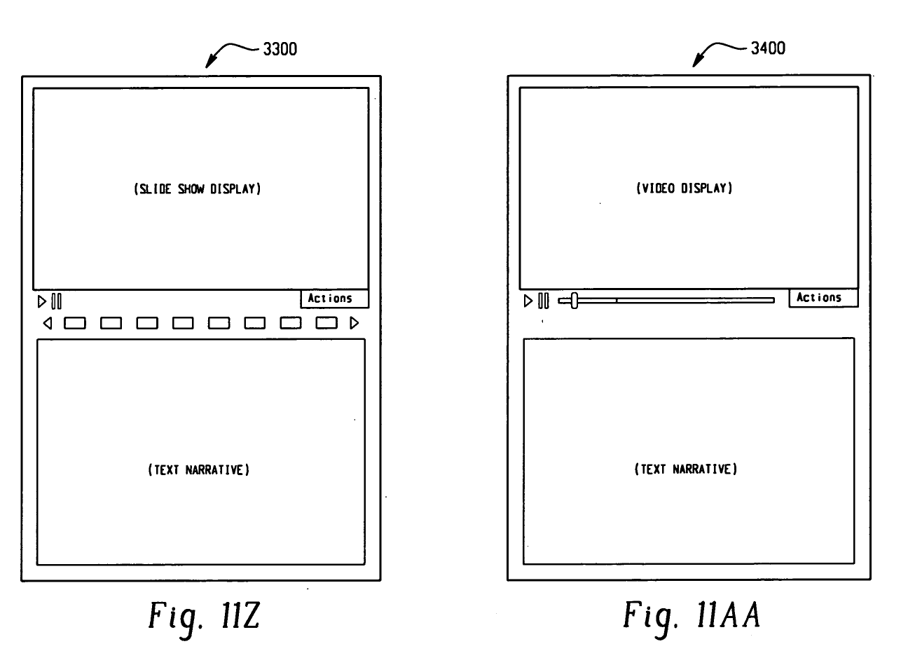

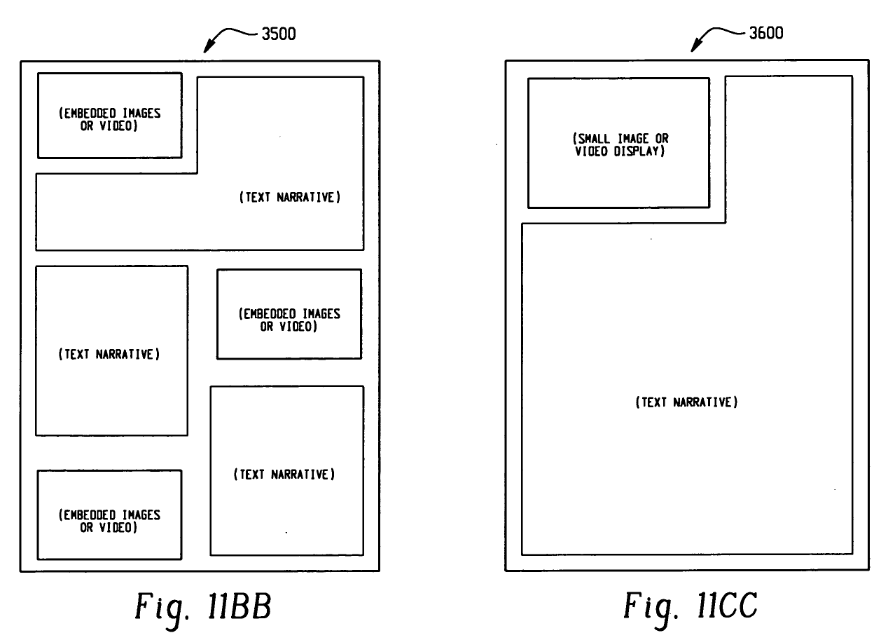

FIGS. 11A-11CC provide additional illustrations of interfaces that can be used with the systems and methods described herein. FIG. 11A illustrates at 800 that the tiering arrangement may assume different orientations. In this figure, the first tier widget is shown in the left-hand portion of the interface and represents the single most related widget to your search criteria area. The second set of widget groupings represents second-tier widgets which are a limited grouping of the second most related widgets to your search criteria (e.g., relatedness indicating that the two assets contained similar metatags). The smallest widgets in the figure are the third most related widgets to your search criteria.

FIG. 11B provides another illustration at 900 wherein distance between widgets is greater if they are not as related. This is shown in the third tier widget that appears in the bottom left-hand corner of the interface. The third tier widget has a greater distance from the primary widget and thus is not as related to the primary widget as the third tier widget that appears in the upper right-hand corner of the interface.

FIG. 11C illustrates at 1000 that a widget it can have multiple display states. In the example of this figure, a first tier widget has two states: condensed (shown in the left portion of the figure); and expanded (shown in the right portion of the figure). In the condensed state, a first tier widget is presented smaller until the user clicks the expand button. In the expanded state, once the user clicks the expand button in the upper right hand corner of the widget, the user sees an expanded view of the widget.

FIG. 11D shows at 1100 a condensed and expanded widget that is associated with a culture symbol. In this example, the culture symbol has a light blue-green color which is indicative of a skateboarding activity.

FIG. 11E shows at 1200 a condensed and an expanded widget that is associated with a culture symbol. In this example, the culture symbol has a dark blue color which is indicative of a snowmobiling activity.

FIG. 11F shows at 1300 a condensed and expanded widget that is associated with a content symbol. In this example, the content symbol has a dark pink color which is indicative of a rally activity.

FIG. 11G shows at 1400 a condensed and expanded widget that is associated with a commerce symbol. This widget contains information related to purchasing a surfing DVD. In this example, the commerce symbol has a blue color which is indicative of a surfing activity.

FIG. 11H illustrates at 1500 two different types of groupings (i.e., grouping by relevance and grouping as a grid) that a user can elect to view widgets. In the left-hand portion of the figure, the widgets are arranged around the primary widget and their distance is indicative of the relatedness to the primary widget. The second type of grouping is shown in the right-hand portion of the figure wherein each tier assumes a particular spatial level relative to the primary widget.

FIG. 11I depicts at 1600 tools for navigating the metadata. The user can use icons shown on the left-hand side of the figure to toggle between the relevance view and the grid view. The user can use the history slider shown on the right-hand side of the figure to return to their previous criteria and corresponding widgets. A history slider graphically represents, through a thumbnail of the data piece, a pre-determined number of previous states of the canvas and the widgets by placing the flag from the primary widget in a linear graph determined by chronology with the newest on the right and oldest on the left.

FIG. 11J illustrates at 1700 that the remote control can be compacted in different ways. For example it can be configured to be compacted differently based upon whether the user is a non-registered user or a registered user.

The remote in its most expanded state reveals all the menus contained therein (e.g., user menu, 4Cs menu and sports menu). These menus contain additional information and shortcuts. The shortcuts allow the user to jump quickly to sub-sets. The menu displays user information specifically in regards to the user's past actions and activity on the site. Example fields include:
Friends: These are the user's friends which are registered users on the site, color-coded by Online or Offline. When a user clicks on the friends field, the canvas is populated by those community profiles specified as friends in the user's profile. The community profile widgets organize by most recently or currently online in the primary tier. If more than one friend is online, the most active friend occupies the primary tier. Friends currently online are denoted by color or other visual means to distinguish from those offline.
Favorites: This contains the number of data pieces stored as Favorites, expressed as a numerical value. When a user clicks on Favorites, all widgets that have been stored by the user in the Favorite section of the user profile, populate the canvas. At this point the user can navigate through all favorite widgets by using the sport and 4Cs buttons, just as they would the site at large.
Published: This contains the number of data pieces a user has published into the site, expressed as a numerical value. When a user clicks on published, all data pieces the user has published populate on the canvas. Through published data pieces the user will be able to view and interact with other related data pieces from the site. For Example, if a user publishes a review of a new mountain bike trail they found, when the user clicks on published, the published review and any data pieces that contain similar meta tags are made available to other users.
Cart: This contains the number of stored, not yet purchased, commerce data pieces and is also expressed as a numerical value. The cart acts as the repository for any commerce widget the user stores in their user profile in the same way they store Favorites. When the user clicks on the cart, all stored commerce widgets populate the canvas. There are two states this can take: 1) just the widgets in the user cart, 2) the widgets in the user cart as they relate to other data pieces on the site.
Purchased: This contains the commerce data pieces that have been purchased. When the user clicks on purchased, all commerce data pieces the user has purchased populate the canvas. When they do this the latest, related data pieces populate with the purchased data pieces.
User's Profile Picture: The user is able to click on their profile picture to access the expanded state of the user profile or the user can choose to Logout of the site to revert back to the Unregistered user view of the site.

FIG. 11K illustrates at 1800 additional configurations that a remote control can assume. In this figure, the control is shown with various parts expanded and contracted.

FIG. 11L illustrates at 1900 the control while primary and other types of widgets are being displayed in the user interface.

FIG. 11M depicts at 2000 an example of a user profile and profile information that is captured about the user. Within the context of a sport-related website, such profile information can include name, user level, age, hometown, hobbies, etc.

FIG. 11N depicts at 2100 a user profile wherein a user can specify which information is public and which information is only visible to their approved list of friends.

FIG. 11O shows at 2200 how a user's information appears in a community widget.

FIG. 11P illustrates at 2300 that a user can drag and drop widgets into their user profile for downloading, for sending to a friend and for removing your favorites.

FIG. 11Q illustrates at 2400 that a user can edit their profile.

FIG. 11R illustrates at 2500 that a download icon changes to a buy icon when a commerce widget is selected.

FIG. 11S illustrates at 2600 that users can sort their widgets by sport, alphabetically or by date.

FIG. 11T illustrates at 2700 different interfaces when uploading content from a computer to the website.

FIG. 11U depicts at 2800 different fields for entering information about an uploaded media asset for use by the systems and methods described herein.

FIG. 11V depicts at 2900 a shopping cart view set of interfaces.

FIG. 11W illustrates at 3000 that if a user browses widgets that are not in “My Stuff” while they are in the “My Stuff” section of the user profile, the navigation switches to enable navigation of the whole site.

FIG. 11X depicts at 3100 example music options that can be used with music media assets for a user.

FIG. 11Y depicts at 3200 an interface wherein user options can be customized.

FIGS. 11Z-11CC illustrate that widgets can handle different media assets. For example FIG. 11Z illustrates at 3300 that a widget can contain a slideshow media display wherein captions change as each image changes in the slideshow. It should be understood that the slideshow can change in response to other factors, such as the slideshow changing based on the user's position of the article. In such a variation, the displayed slideshow image corresponds to a particular area in the article and changes as the user scrolls through the article. FIG. 11AA illustrates at 3400 that a widget can be a video media display. FIG. 11BB illustrates at 3500 that a widget can have embedded images within narrative text. It should be understood that other variations exist such as the embedded images can contain both still images or video. FIG. 11CC illustrates at 3600 that a widget can provide a small image or video display within narrative text.

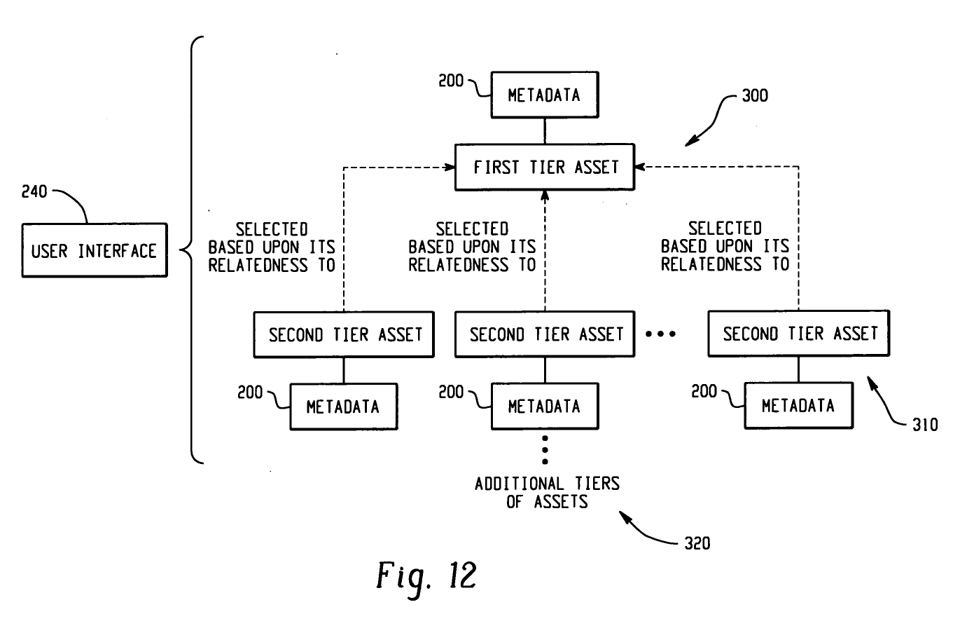

As indicated above, FIG. 12 illustrates that non-first tier assets are selected for display based upon its relatedness to the first tier asset. Metadata 220 associated with each asset is used to determine the degree of relatedness to the first tier asset.

The system can be configured to use the same exact hierarchical, scored metadata schema to catalog every data piece that is present in the system and on the site—that is, a set structure is used for everything from new content to new community members. To assist this approach, the vocabulary of the system could be closed and people are not allowed to enter random key words. This works such as, inter alia, a niche market like action sports where, because of the tight focus of information, there is usually only a slight variance in relevant information from all areas encompassed by the site: community, content, culture, and commerce. However, it should be understood that the system is also applicable in non-niche applications.

When a user is publishing work into the system or registering in the community, the user is guided by a predictive database search mechanism which matches keywords pre-existing in the system to that which the user is entering. That is, when the user types in a key word into a given field, the system matches that word to the vocabulary in the database and prompts them to key words currently in the system. The user can contribute key words to the system, but this is verified by administration to ensure only relevant key words are added to the system. It is the consistent use of an established key word lexicon across all types data pieces combined with the scoring or weighting of the key words in their given category of the schema that allows efficient search functionality and flexibility to deliver the closest possible data piece to a given search or preference. In addition it allows for customizable, convergence and dynamic advertising.

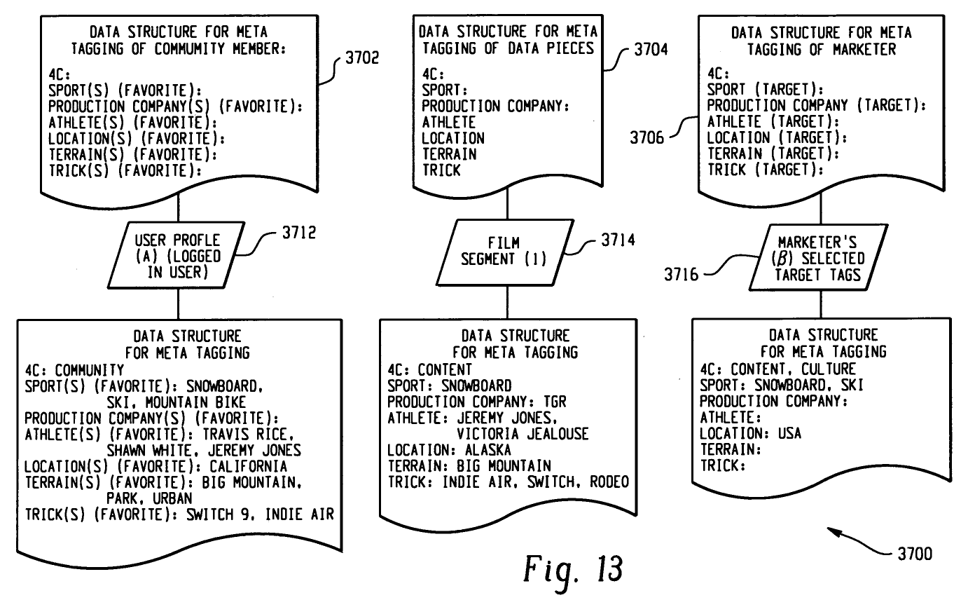

FIG. 13 depicts at 3700 examples of metadata tagging for different data items. More specifically, a data structure is shown for metatagging of a community member 3702, a data piece 3704 (e.g., a media asset), and a marketer 3706. Each of the data items contains a common set of metadata tagging fields. In this example of FIG. 13, the common set of metadata tagging fields includes: a category field (e.g. 4C: culture, commerce, contact, and community), a sports field, a production company field, an athlete field, a location field, a terrain field, and a trick field. It should be understood that the common set of metadata tagging fields can change depending upon the situation at hand and that the fields shown in FIG. 13 are provided by way of an example and not meant to limit the range of metadata tagging that can be done for a data item.

With reference to FIG. 13, the user profile for a particular user 3712 contains the following metadata tagging information:
4C: Community
Sport(s) (favorite): Snowboard, Ski, Mountain Bike
Production Company(s) (favorite):
Athlete(s) (favorite): Travis Rice, Shawn White, Jeremy Jones
Location(s) (favorite): California
Terrain(s) (favorite): Big Mountain, Park, Urban
Trick(s) (favorite): Switch 9, Indie Air

The metadata tagging information for the film segment data item 3714 is as follows:
4C: Content
Sport: Snowboard
Production Company: TGR
Athlete: Jeremy Jones, Victoria Jealouse
Location: Alaska
Terrain: Big Mountain
Trick: Indie Air, Switch, Rodeo

The metadata tagging information for the marketer data item 3716 is as follows:
4C: Content, Culture
Sport: Snowboard, Ski,
Production Company:
Athlete:
Location: USA
Terrain:
Trick:

FIG. 14 depicts at 3800 a process flow by which the metadata tagging fields can be utilized in order to search for related data items. As shown in this figure, when a user logs in, the user's profile is retrieved at step 3802. The metadata tagging information (retrieved based upon the user profile as well as any search criteria provided by the user) is used to conduct a search, such as using the “snowboard” and “content” search criteria that has been specified by the user.

A relatedness algorithm at step 3804 is performed using this information in order to determine a media asset that is most related to the input search criteria. The media asset whose metadata is most similar to the input search criteria is determined to be the primary widget. In this example the film segment item 3714 of FIG. 13 is determined to be the primary widget and is returned.

The system also performs at step 3806 an advertiser placement algorithm by examining various marketers' target tags in relation to the metadata tagging information associated with the user profile and the film segment which is the primary widget. The system returns the highest ranked marketer's advertisement 3808 for display on the canvas.

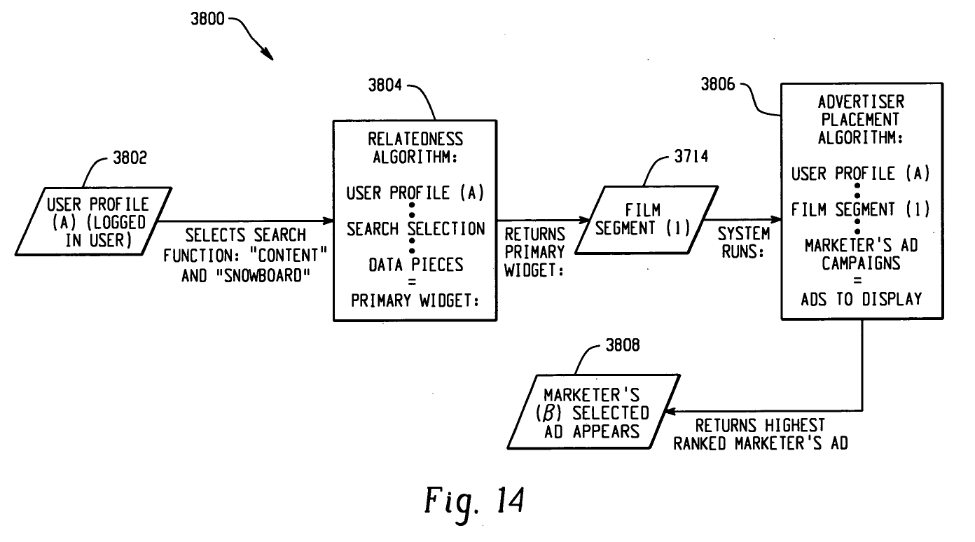

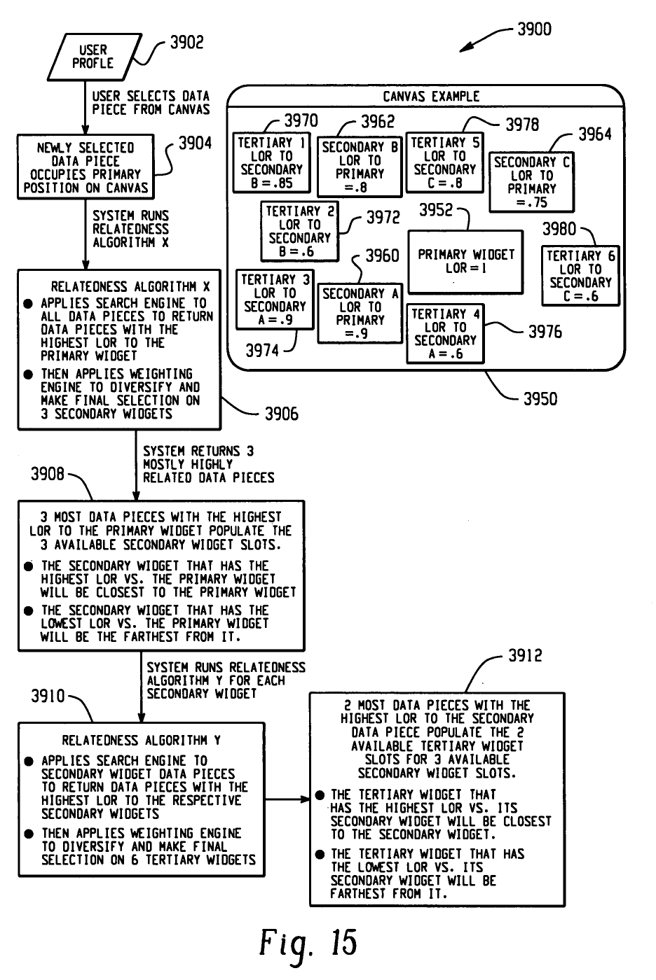

FIG. 15 provides at 3900 additional details regarding the process of FIG. 14. In general, when the user runs a search (whether engaging the menu buttons or clicking on a widgets) the system can be configured to run several algorithms, such as the following two algorithms (either separately or concurrently): The first is to determine the closest matches in the data base or the 1st degree of separation, the second is then run against those matches but for additional information.

The second algorithm utilizes the metadata and the score of the data contained in every data piece. This algorithm sources the other categories (e.g., 4C categories) first, to pull related data pieces from those categories first. As an illustration, it can be run on athletes, production companies or other contributors stored in the data base (but not included in the meta data schema). Based on matches from this second search, a 2nd degree of separation is determined. The 2nd degree of separation then is given a multiplier value (which can be controlled by administration). The 1st degree and 2nd degree (after the multiplier is applied) combine to determine the level of relatedness or separation of data pieces delivered as a result of the search.

All individual pieces of meta data within the schema for a specific data piece are given a score. Meta data for Content and Culture are given a score based on the subjective quality of that Category accounted for in the data piece. Meta data for Community is scored based on combination of user preference and user activity (both the navigation history and the aggregation of key words from saved data pieces). Meta data for Commerce is scored identically to the Content and Culture data pieces it should populate with. The scoring of data pieces allows administration to control the population of data pieces on the site, which is to say scoring allows the administration to push data pieces down and pull them up and generally control how the system delivers the data pieces to the user. Through such an approach, the system has an artificial way to skew the results of the search to consider who is searching, what the administrators want to deliver, the highest quality direct match, or a host of other biases.

More specifically with respect to the example at hand and with reference to FIG. 15, the user profile information 3902 is used to select a data piece from the canvas as shown at 3904. The newly selected data piece 3952 occupies the primary position on the canvas 3950. The system determines which digital items are most related to the selected data piece. The relatedness algorithm 3906 performs a search upon all the data pieces and returns those data pieces with the highest level of relatedness to the primary widget. A weighting engine is used to diversify and to make the final selection on the three secondary widget. The system then returns the three most highly related data pieces. These three most highly related data pieces populate the three available secondary widget slots (3960, 3962, 3964). The secondary widget that has the highest level of relatedness with respect to the primary widget will be the closest to the primary widget. The secondary widget that has the lowest level of relatedness with respect to the primary widget will be the farthest from it.

The system then runs the relatedness algorithm 3910 for each secondary widget. This algorithm performs a search upon the secondary widget data pieces in order to return those data pieces with the highest level of relatedness to a secondary widget. The algorithm then may use a weighting engine to diversify and make the final selection on six tertiary widgets (3970, 3972, 3974, 3976, 3978, 3980).

As shown at 3912, the two data pieces with the highest level of relatedness with respect to a particular secondary data piece will populate the two available tertiary widget slots for each secondary widget. More specifically, the tertiary widget that has the highest level of relatedness with respect to its respective secondary widget will be closest to the secondary widget. The tertiary widget that has the lowest level of relatedness with respect to its respective secondary widget will be the farthest from it.

FIG. 15 shows an example of a tiered arrangement of widgets based upon the results of the process of FIG. 15. As shown in the canvas example, the primary widget 3952 with a level relatedness of “1” occupies the primary position on the canvas. The three secondary widgets (3960, 3962, 3964) have a smaller size with respect to the primary widget and their distance from the primary widget is based upon their level of relatedness. For example, the secondary widget A (with a level of relatedness with respect to the primary widget of 0.9) is closer to the primary widget than the secondary widget C (with a level of relatedness with respect to the primary widget of 0.75).

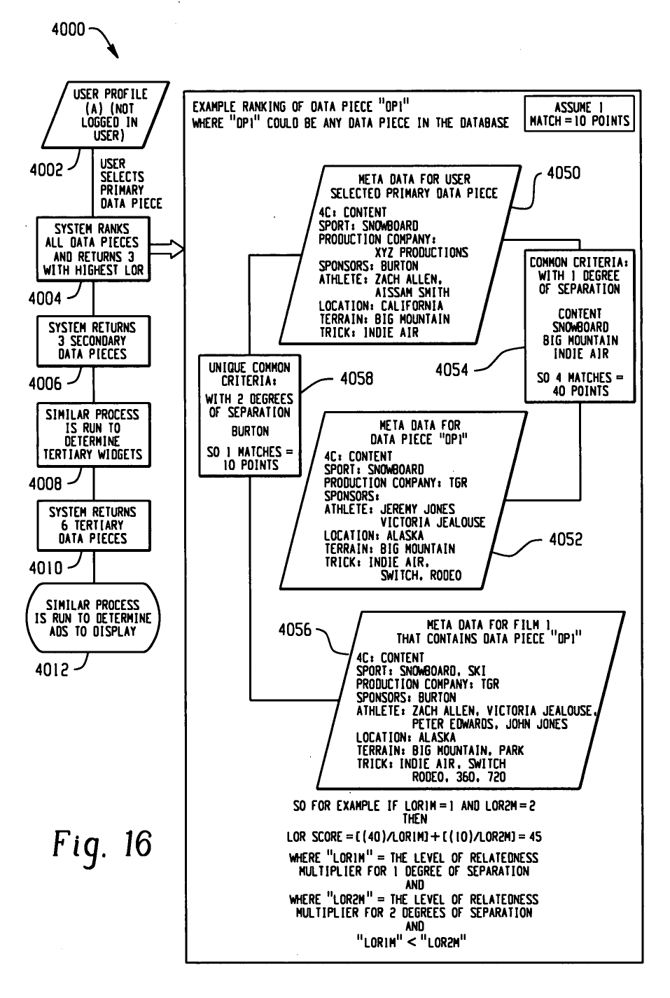

FIG. 16 provides at 4000 an example calculation of determining the level of relatedness between the user selected primary data piece of FIG. 15 and two other data pieces that are in the database. With reference to FIG. 16, the process for this operational scenario begins at 4002 with the user selecting a primary data piece. The system ranks at step 4004 all the data pieces and returns the three with the highest level of relatedness with respect to the selected primary data piece.

As an example of a relatedness calculation, the metadata for the user selected primary data piece 4050 is compared with the metadata for a candidate data piece “DP1” 4052. The algorithm compares how many metadata data values match between the selected primary data piece and the candidate data piece “DP1.” In this example there are at 4054 four matches and if one match is equal to 10 points, then with four matches the comparison yields a point total of 40. A similar comparison is performed at 4058 using the metadata for the film 1 data item 4056 that contains data piece “DP1.” In this example, there is only one match which yields a point total of 10.

Using these calculations and if LOR1M=1 and LOR2M=2
Then,

LOR Score=[(40)/LOR1M]+[(10)/LOR2M]=45
Where
   “LOR1M” =the Level of Relatedness Multiplier for 1 Degree of Separation;
   “LOR2M” =the Level of Relatedness Multiplier for 2 Degrees of Separation; and
   “LOR1M”<“LOR2M”

After these calculations, the system ranks the data pieces and returns the three pieces with the highest level of relatedness. The system returns at 4006 the three as the secondary data pieces. A similar process is performed at 4008 to determine the tertiary widgets. The system returns at 4010 the six tertiary data pieces based upon the level of relatedness calculations. Lastly at 4012 a similar process is conducted to determine which advertisements are to be displayed.

An effect of the processing shown in these flow charts is that the user interface assumes a form of dynamism. Via the processing, every choice the user makes involves a multi-tiered search function that places a call into the database to match the various values plugged into the meta data schema of the chosen data piece. If desired, a real-time dynamic interface (e.g., an Adobe Flash-based implementation) can allow for the dynamic return of search results and population of the canvas with the searched for data piece. It is noted that what is returned from the search is the actual data piece (e.g., media asset) and those that are most closely related to that data piece that are directly displayed to a user (e.g., a hyperlink does not have to be activated to see the media asset).

The processing allows for navigation of the dynamic user interface through searching of a relational database that has a set meta data schema for comparing disparate mediums for contextual similarity. The resulting matches are then delivered through the population of data pieces on the canvas in a visual representation of their level of relatedness and the type of data piece (e.g., culture, content, commerce, community).

The navigational system of this platform allows all forms of media (video, audio, film, print, graphics, etc.) to coexist, equally in one dynamic space. If there is a print article that is contextually relevant to a video segment, and even though they exist independently from one another, propagate together and are, until expanded to reveal the specialized tools, visually similar. In this way, a user can compare dissimilar mediums by contextual relevance, not by visual disparity.

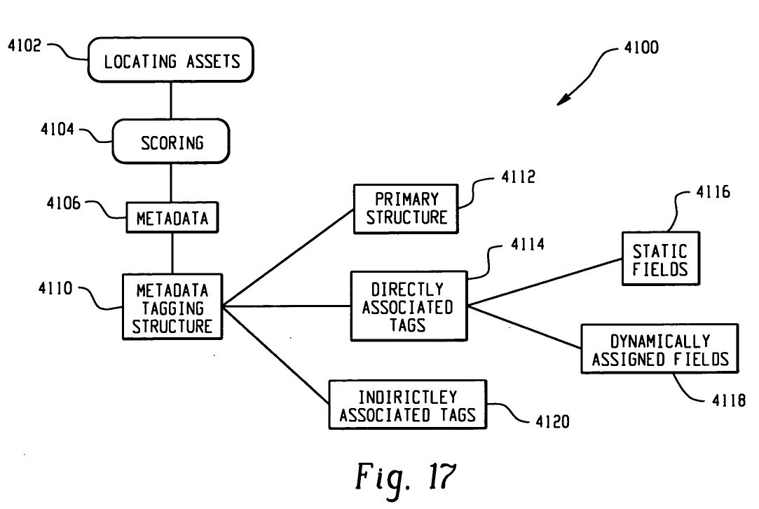

It should be understood that for the metadata 4106 the metadata structure can assume many different forms, such as the metadata structure shown at 4100 in FIG. 17 that is used in the locating 4102 and scoring 4104 of assets. The fields in the metadata tagging structure 4110 can include a primary metadata tagging structure 4112 to contain the fields mentioned above for searching and scoring. Additional fields can also be used and are associated with the primary metadata tagging fields both directly and indirectly.

The additional fields 4114 that are directly associated can be made up of two elements. The first are static fields 4116 that are always associated with a particular item, this includes more data similar to what is listed in the metatagging field list (e.g., criteria that will not change). Examples include date entered in the system, expiration date, system exclusive, etc. The second type 4118 of additional fields are assigned dynamically. This could include items such as “featured content,” “best tricks,” etc. These “dynamically” assigned tags change as the system changes. Some of the changes happen automatically based on site statistics, while others are set by system administrators. This second, dynamic association can also be used for handling advertising on the site.

The additional tagging fields 4120 that are associated indirectly form the basis for a hierarchical tagging structure. The Category structure is hierarchical—that is, the first category is deemed more important and also broader, the second category is less important than the first, but also slightly more specific, etc.

There are two elements to the hierarchical tagging structure. First is the additional meta data that is associated indirectly with a particular item. For example, meta data that is associated with a DVD from which a particular segment is cut exists in the second layer of the meta data hierarchy for that particular segment of the DVD and would be scored accordingly (with a lower degree of relevance).

The second criteria that creates the “hierarchy” of metatagging fields is the biasing introduced by the algorithm that determines relatedness. This “bias” is created by artificially weighting some fields as being more important than others. Nearly all meta data fields are included in the algorithm that determines how related any piece of data is to any other. All of the fields included in the algorithm have a rank or weight associated with them.

For example it may be determined that “sport” is very important in determining how related one piece of data is to another so we could assign it a weight of 2, additionally we may decide that “production company” is not nearly as important so we will assign it a weight of 0.5. In this example when the relatedness algorithm is run, a match of meta data within the “sport” category would generate a score 4 times that of a match in the “production company” category. In this way a hierarchy among the tags is created as to which is most critical in determining the level of relatedness of one item to another. Because of such an approach, associations within the site are fluid (e.g., dynamically changing) in which every item has a “level of relatedness” to every other item.

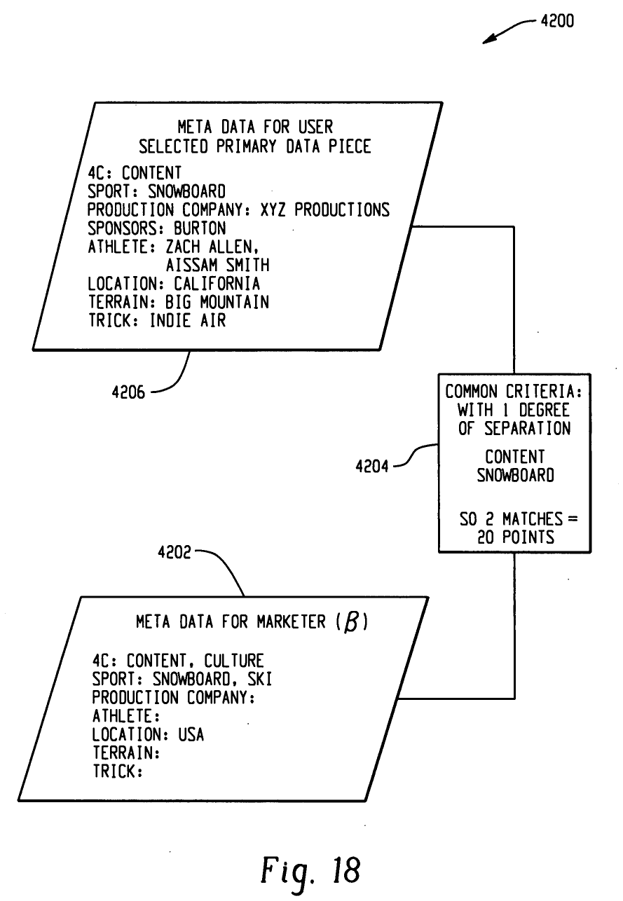

FIG. 18 provides at 4200 an example of applying the relatedness algorithm to the advertising context. The advertiser or advertisers that are deemed most related to a selected data piece will be selected to populate the user interface with their respective advertising information. In the example of this figure, the metadata for the marketer data item 4202 is compared at 4204 with the metadata for the user selected primary data piece 4206. There are two matches and accordingly 20 points is used when determining the level of relatedness to the primary data piece. Accordingly, advertising functions almost identically to how a data piece (e.g., content) is entered and handled by the system.

For advertising, there can be a set of overriding rules that can trump this behavior. For example, if a particular marketer wants to ensure that their advertising (e.g., canvas advertisement skin) will always appear with a particular athlete, they can pay a premium to override the “level or relatedness” scoring system and always appear with a particular athlete, piece of gear, etc.

A marketer can choose what key word they would like to advertise against from the available categories. There are several factors that are taken into account: the user, the Database and Advertiser(s) in producing a value for the key words selected. The advertiser can chose a very broad key word(s) e.g., snowboarding and the CPM (“cost per thousand” ad impressions) could be fairly inexpensive because there is great depth of content with that key word and therefore many opportunities for the advertising to appear.

The advertising system can also be setup as an auction, so any given advertiser can bid up their position in the site. For example, advertisers are bidding against a particular value (100%) and can chose how much they are willing to spend to increase their chances of owning that entire value. The system functions in such a way that broad key words are only expensive by the number of advertisers vying for a portion of the finite number of data pieces. Key words that are broad, but at a relatively high level (a specific popular athlete and sport) are generally more expensive.

Key words that are hyper specific or factor in just a portion of the Registered user s looking at the content by advertising against a specific zip code, are generally inexpensive. The cost of advertising on the site is also determined by the type of advertising package (an established stratification of price points) the advertiser chooses to buy into.

The advertising system can also generate advertising as follows. An advertiser can chose the key words in the system they want to populate with. The advertising that populates is a result of the key words and the number of times a given advertiser, from the set of advertisers that have chosen those specific key words, have populated. The system rotates through the pool of advertisers vying for specific keywords and advertisers only pay for the number of times their ad shows. They set a price limit at the time of signing up, so they will exit the rotation after that maximum price is reached (or based on another over-ridding criteria).

With respect to product placement, the system by virtue of the dynamic user interface allows the viewer to choose the content which calls the most related data pieces from each one of the primary asset types (e.g., one of the 4C types; that is, each of the 4Cs should be represented in the primary or secondary tier). This results in advertising that is associated with the key words. Accordingly, the system delivers contextually relevant data pieces across what were previously disparate mediums. For example, if a user chooses to watch video content that includes snowboarding, and there was a Culture review of the specific board in the video, the site would retail that snowboard and the manufacturer of that snowboard could choose to advertise against their own name or their athletes' name (or both). The result is the ability to capitalize on impulse purchase from product placement. This sort of all-inclusive contextual interconnectivity is significant differentiating factor.

The advertising system can also address branded content. The system allows branded content to cohabitate with the rest of the content on the site, but populate only in areas the advertiser chooses.

The site can also be configured to be fully customizable to the advertiser. As an illustration, every piece of the user interface can be purchased and customized by an advertiser to strengthen their presence in a given area. The entry level is the canvas. The canvas acts as the fourth tier, which is to say, the entire canvas changes to reflect advertising (e.g., a static advertisement image) connected to whatever widget is called into the primary position. However it should be understood that every facet of the site can change and not just the canvas, including but not limited to, the border around the widgets, the pre-roll, post-roll, the colors of the site, etc.

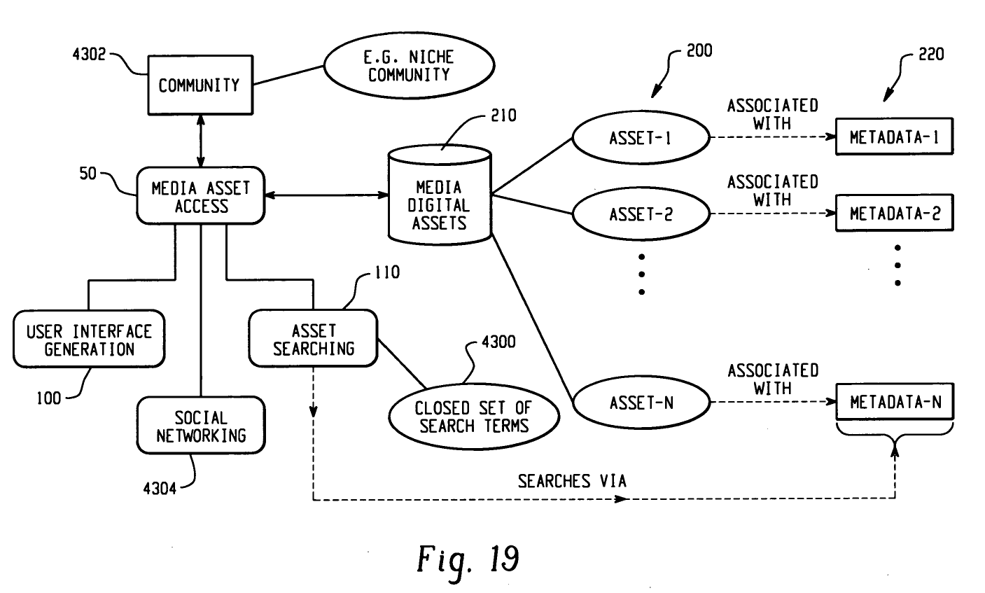

As mentioned above and as illustrated in FIG. 19, a closed set 4300 of search terms can be utilized for searching through use of a relatedness scoring algorithm. With a closed vocabulary of search terms, users are not allowed to enter random key words. This works well for a niche market like action sports where, because of the tight focus of information, there is typically only a slight variance in relevant information from all areas encompassed by the site: community, content, culture, and commerce.

A community 4302 (e.g., a niche community) can also be identified that are either actively producing content or have dormant content available. The system 50 can be configured to provide social networking 4304. Once this community has been identified, the content is consolidated either through outright purchase or contractual agreements with content producers or both.

Because proprietary content (that is not currently distributed through new media channels) is licensed or purchased for the site, the company can adjust their revenue model as needed. It can be commerce centric or advertising centric or a balance of both.

The site can also provide a forum for users to syndicate their content online as well as provide content (aggregated from its users) to third party websites. In addition, the community members could have the option to submit their own content to be syndicated to a vast host of sites on the web. Revenue from embedded advertising could be divided between community member and company.

The platform and system can be offered free of charge to brands in the particular space in which they create content. When a user enters the site from the brand side, all brand's content would be present and the site's environment would look and feel like the brand. However, if a user came in from the site, all of brand's assets would live on the branded site. Thus, the site erects more significant barriers to competition. In addition, the website could adopt a similar approach with magazines in the given niche market. In this case, the site could create online archives of past issues which will live in the system. Again, if user comes in from magazine side, the user will see the archive in totality. If user comes in from via the site (i.e., website), they can have access to the archives which will make the contextual database search engine incredibly sophisticated as it is largely dependant upon depth and breadth of data pieces in the system.

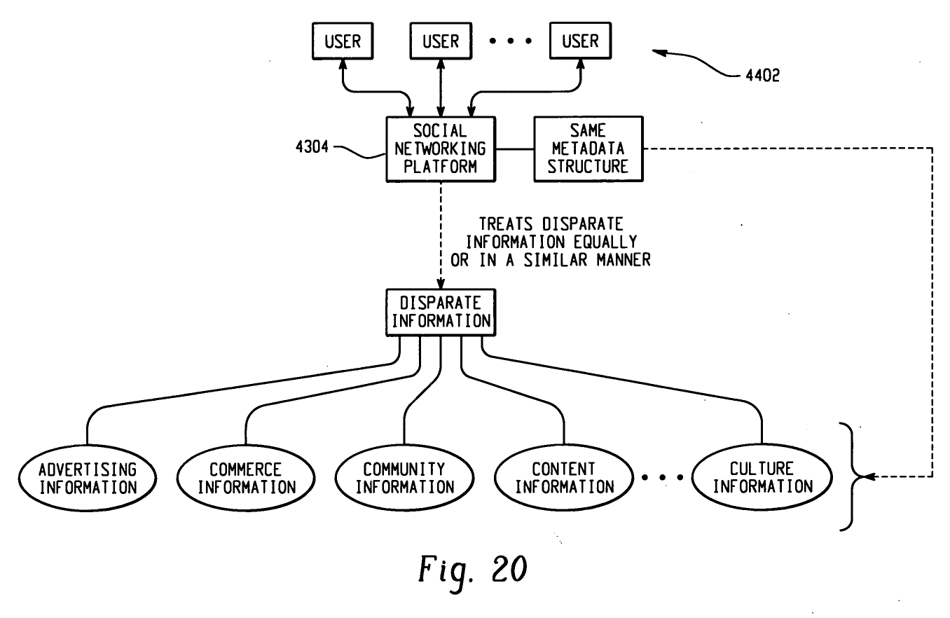

FIG. 20 provides an additional illustration of how the social networking for users 4402 and its platform 4304 are integrated with advertising. The platform treats all pieces of information equally—that is, advertising, community, commerce, content, culture, etc. are built on the same metadata structure (e.g., uses the same metadata schema in a relational database environment).

In other words, by structuring advertising just like all other information, it facilitates capitalization on contextual messaging. The advertiser can pin-point their customer by choosing the relevant key words in the system. Through such an approach, the system not only allows for targeted advertising, but allows for a fully customized brand experience, e.g., by determining the chosen advertising space, viewing content produced by that brand, and then purchasing that brand's product, all within one environment.

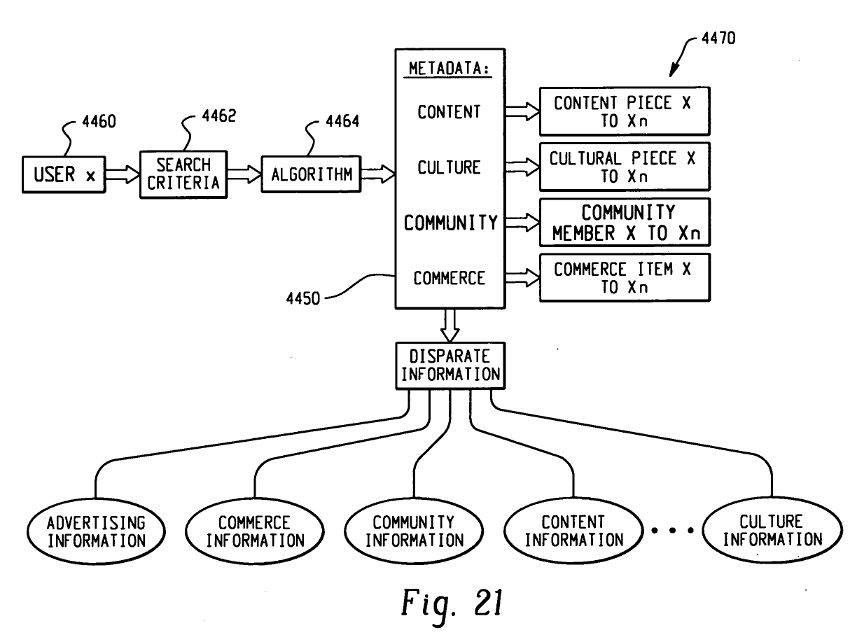

FIG. 21 further illustrates that the approaches described herein heighten the degree of social networking among the users. For example, the metadata structure 4450 and searching approaches (e.g., search criteria 4462 being provided in relation to user x 4460 and processed via relatedness and ranking algorithm 4464) described herein interconnect multiple different items 4470 to form relationships that would not have existed but for the interconnectivity approaches described herein. Such interweaving of disparate items (e.g., community information with commerce information with content information, etc.) allows connections to arise that a user might not have otherwise realized. A user watching a video will automatically have surrounding the video, community information, commerce information, advertising information, other content information, etc. These data pieces have been automatically selected based upon their relatively high degree of interrelatedness, as determined by similar meta data, with the chosen video, and their locations relative to the playing video further reveal their respective degree of interrelatedness with the video.

As an illustration, a user can be watching a video of a snowboarding event, and will have immediate access to related information, such as culture information that provides dates and locations of upcoming snowboarding events. Other culture information surrounding the snowboarding video could be related to where the best snowboarding locations are relative to where the user resides and what the current and next 10 days' weather forecasts are for such locations. Community members who have similar meta data (e.g. activity or location) would emerge from the system. Similar content such as more clips of the same athlete or production company, etc would also populate. And any equipment, gear or other saleable item that was present in that clip would populate from the commerce section.

The culture information could also include what other users (e.g., friends) on the site are planning on attending which upcoming snowboarding events. Upon viewing the upcoming snowboarding events, a user can communicate with other users via the social networking platform to try to arouse interest in attending a particular snowboarding event and to share video or culture information related to the snowboarding event.

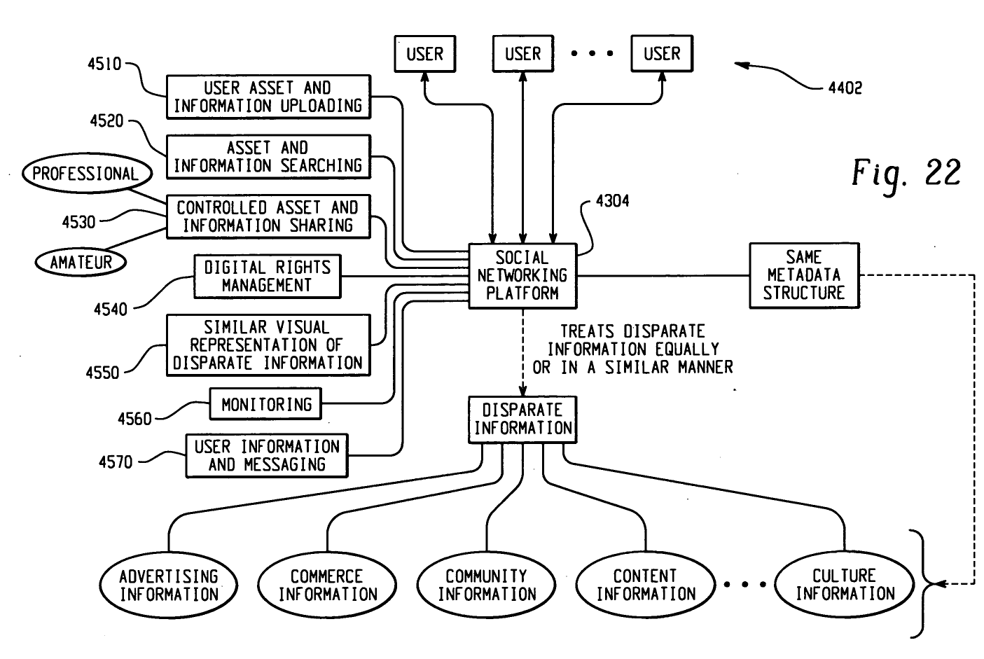

As further illustrated in FIG. 22, the platform 4304 of the system provides for proactive social networking through one or more features or functionality (e.g., as shown at 4510, 4520, 4530, 4540, 4550, 4560 and 4570). For example, the social networking platform 4304 utilizes the sharing 4530 of media to facilitate connection between people. The site connects people by activity, both on the site and activities they say they participate in. Because people tag themselves using the exact same closed meta data structure all data pieces in the system use, everyone uses the same database vocabulary which makes the algorithm function efficiently. So when a user looks themselves up on the site, it pulls other people who are most similar to them from the database in the same dynamic way all other data pieces populate on the site; pulling those data pieces that are most similar to the user. As an illustration, if a first user is really involved in one activity, and another user who lives in the same town is exploring the content produced in or submitted by a person in that town and it is all about the activity the first user likes, the first user's profile will populate on the canvas. As another illustration, if the first user performs a search 4520 for herself on the site, her profile will come up, and also pulling those people who are most similar to her, thereby allowing her to network with people who are like her in preference and action on the site. The system uses the aforementioned relatedness algorithm that not only factors in what a user looks at most often, but the density of key words in the content the user has stored.

Users can perform uploading at 4530 of their own content (video, photographs, text) onto the site and store it in their profiles. They can then choose to publish it into the system. When the user publishes into the system they are given the set meta data schema to tag their own content in exactly the same way the site administrators do. The predictive search mechanism guides the user to enter key words that are currently in the system. Users can enter key words that are not in the system, but because they are actually sending to the site administrator to post on the site, the site administrator approves the content and new key words or rejects them. By allowing the user to use the key words in the database, the user's published content lives in the system with all other data pieces and populates with things that are contextually similar, regardless of whether they are professional or user generated. The site visually distinguishes between user generated content and professional content so that the user can always access the type of content they are interested in at that time.

The system can also include a monitoring software system 4550 that keeps a watch on which content has become popular with other members. The authors of the popular content can then be signed to a contract to exclusively (or in some other capacity) provide content to the site. This monitoring capability allows for easier detection of talent and will allow the site to become the proving ground for new talent which will keep the site fresh and populated with new content.

The user interface generation software system 4560 allows for the tiering approach described herein to be used within the community. With visually similar representation in the user interface, disparate pieces of information (community members, music, photographs, articles) can be easily compared through the tiering systems which demonstrates the level of relation each data piece has to one another.

The website user pages are designed to be used as personal websites that can handle mass amounts of visual data (video, photographs). As shown at 4530, the website can share such data (e.g., video, pictures and text) with “friends” but also with the community at large. User generated and submitted content is a source of content, but also a powerful incentive for participation and therefore traffic on the website. As such, the user is able to log directly into their personal page.

Via the sharing software system 4530, the community can share media in a visually based system. The community can be composed with friends, crew members, etc. With respect to friends, a user can make any professional (pro athlete or production company) their friend without permission. This acts as a way to show who they like and identify with. Non-professionals on the site have to approve friend requests. The system can also be configured to allow the user to chose how they want the media despite how the original medium was packaged (e.g., DVD, CD, Print Subscription, digital, etc.). With the digital choice, the user can chose what platform they desire (e.g., iPod, PSP, IPTV, Desktop or just saved to their profile).

With respect to crew members, a user's crew is only a very select number of friends (e.g., six). Through use of digital rights management techniques 4540, the user is able to share purchased, DRM protected content with these community members. In this way, the system allows for the cohabitation of user generated content as well as professional content. Furthermore if desired, the system can be configured such that only the professional content can be digitally rights managed, protected using the latest encryption technologies.

The user can send any protected content to their crew, but when the receiving crew member tries to take it off the site, they are charged the normal price of the content. The receiving crew member can watch the content or a portion of that content on the site. The user can add and delete crew members at will, but can only increase the number of people in their crew by uploading a certain amount of content.

Return users can log directly into their website page or new users can create a profile instead of going into the site such as through the user information software system 4570. When a user chooses to login they are redirected to the homepage that is reflective of their preferences. Via the system 4570, the user can establish and save their preferences in their profile. The sum of all established preferences equals the User Preference Scoring System (UPSS). The widgets that appear on the canvas are determined by the UPSS in relation to the Database. The canvas has the technical ability to accommodate any number of widgets.

Many different preferences can be used to describe the user within the community. A non-limiting list of preferences can be as follows:
My Profile: The user profile interface can be divided into three portions
   Profile: 1^{st} 3rd
      Profile Picture/Video/Graphic
         Access to Media Center (click)
      Username
      Quote
      User Type (can combine)
         Regular User
         Pro Athlete
         Industry Employee
         Writer/Photographer/Cinematographer/Director/Producer
         Production Company
         Action Sports Company
      Personal Stats (dependant upon User Type): This is what is viewable when user profile is in primary widget form.
         Sports
         User Type
         Sex
         DOB (optional)
         Height/Weight (optional)
         Home Base
         Occupation
         Ideal Occupation
      Preferences:
         Favorites
            Athletes
            Gear
            Locations
            Action sports films
            Rider Segment
            Tricks
            Music
            Drink
         Sports (dependant upon user Type)
            Regular User
            Years Riding
            Where I ride
            Best Moment
            Set up
            Best trick
            Style
            Pro Athlete
            Industry Employee
            Writer/Photographer/Cinematographer/Director/Producer
            Production Company
            Action Sports Company
         Open Field/Personal Narrative

User messaging operations 4570 can be implemented via a messaging center. A messaging center area can be provided as an area of the user profile that allows for intra-site communication. The center can be used as IM (Instant Messaging) when the user is logged on as well as traditional email. Users can send messages and content to other users on the site. This provides the ability to send media (e.g., files that would be impossible or difficult to send via normal email because of their large size) as well as communicate with other users. Users can send long pieces of video and many still photographs pulled from anywhere on the site, or their assets that they have purchased, uploaded, or are in their favorites, etc.

The center can be designed so that it makes receiving content easy and user friendly. For every message that is received the sender's profile picture and user name is included under the From heading, there is also a visual representation of the attached content in the form of a thumbnail. When a message is clicked on, the “body” of that message pops up as a widget in the canvas area. At this point the message will indicate if the sender is online. If the sender is online the receiver can choose to IM them, if the sender is not online the receiver can reply as a regular email. The receiver can also choose to click the sender's profile picture and the sender's profile will populate on the canvas. The receiver can also click on the content that is attached to the message and that content will populate on the canvas. It is at this point the user can choose to direct content into their Media Center or their Favorites.

The site can also include the following features:
Who's Online: users that are currently online are indicated by a glow around their profile image.
Pages: users can have an infinite number of friends, however at a certain point (e.g., around 15-20) the friends will continue to aggregate on additional pages that can be clicked through.

Via the software system 4570, a media center can also be provided where the user's friends and crew are aggregated The media center is the area where the user stores their content. This includes uploaded content, purchased content and content that was uploaded by another user (distinguished from content published by another user) and content purchased and sent by crew members. Navigational tools can be provided for use by the user to navigate and sort data pieces on this page, such as the following:
Upload: This button takes the viewer through the process of uploading their own content onto the site.
   Browse: The user chooses the file from their desktop.
Publish: The publish button takes the user to the area to create their publication.
Source: This is how the user selects data pieces from the storage area.
   Purchased: A user's purchased content is stored in this area.
   Mine: The user's uploaded data pieces
   Crew: data pieces sent by the user's crew and saved by the user.
   Friend: data pieces sent by friends and saved by the user.
Browse: An additional sub-level of organization:
   A to Z
   New to Old

A storage area can be provided where the content is stored and represented by small, still images. The content is organized in a linear fashion, with a limited number images appearing in the storage area window at one time, but the ability to scroll left or right through the images as needed. The storage area can also include the following:
Volumes: The user has the ability to organize the content into Volumes, or a grouping of various types of media uploaded or purchased by the user or the user's friends and crew. For example: If a user went on a trip they can upload photographs, video and text from that trip and organize all those assets into one Volume. Users can combine their own uploaded content with purchased or their crew members'. This allows for a collective and participatory organizational system in which many people can pool owned or personal content assets to create one. This singular asset can be accessed by many and distributed to other members' profile easily and efficiently. The Volumes come with icons on the bottom of each image that signify what type of assets are contained within that Volume, e.g., photographs, video and/or text.
Organization: There are multiple choices in how a user can navigate content in the Storage Center
   Source:
      Mine: User's uploaded content
      Friends: Personal content that has not been published into the site provided by, or taken from, a friend.
      Crew: Personal content that has not been published into the site provided by, or taken from, a crew member.
      Purchased: Any content that is purchased from the site, including purchased content sent by a crew member.
   Intra-organization:
      Alphabetically
      Chronologically
Sharing: The center cohabitates with the user's community of friends. This facilitates the ability to drag and drop data pieces. A user can drag and drop a data piece (a Volume or a singular data piece) onto a friend's Icon. The data piece or pieces can automatically be sent to the chosen friend's Message Center. The receiving party can chose to save or discard the data pieces. In the event they save it, it is sent to their own Media Center. The user is able to share an unlimited number of personally uploaded data pieces (organized into Volumes or singular) and purchased data pieces with a broad network of chosen community members.
   Sharing purchased data pieces: A user is able to share purchased data pieces with their crew. With shared purchased data pieces, the recipient of that data piece is able to view it on the site, but is unable to take it off from the site without purchasing it themselves. This engenders intra-site sharing and will ultimately foster additional commerce.
Publish: A user can publish any of their uploaded content.
Content Viewer and Publishing Area: This area of the site, while bigger than all widgets, closely resembles them in layout and functionality. This helps maintain consistency in form and feature. This feature of the site allows the user to assemble photographs into Volumes or into data pieces that they would like to publish into the site.
   Image Area and Tools: The image area is where the user can view a data piece. The tools present on the viewer are determined by what type of data piece is being viewed, e.g., if there are photographs, then tools to build/play a slide show would be present. There are also tools to edit and assemble. The user will be able use editing tools to edit their videos, include music, photographs and then publish them into the system or save them as Volumes.
   Actions:
      Publish: A user can publish their work into the system. When a user publishes into the system, they enter their own meta-tagging for that piece. When the user does this, they fill in the same set structure that the rest of the content uses. When they fill out this form, it is predictive/suggestive and matches what the user is entering to what is in the database. By structuring the tagging of the user, it ensures that the content will function harmoniously and efficiently with the rest of the site. This keeps the contextual search accurate and tight.
      Save Volume: Save your work
      Delete Volume: Delete your work
      Send to a Friend: You can drag and drop for your friends on the site, but this allows you to quickly send to a friend off from the site.
   Text Area: This is where the user can write their story or their captions. There are functions similar to those on Microsoft Word.

A place (e.g., a “stuff” place) can be established where the user can store data pieces gathered from other areas of the site. The user can save data pieces in this section in each of the categories, and then navigate through the content using the same navigational tools provided on the site at large. The user is able to create their own personal site populated with just the data pieces the user wants.

While examples have been used to disclose the invention, including the best mode, and also to enable any person skilled in the art to make and use the invention, the patentable scope of the invention is defined by claims, and may include other examples that occur to those skilled in the art. Accordingly the examples disclosed herein are to be considered non-limiting. As an illustration, it should be understood that similar to the other processing flows described herein, the steps and the order of the steps in the flowcharts described herein may be altered, modified, removed and/or augmented and still achieve the desired outcome. A multiprocessing or multitasking environment could allow two or more steps to be executed concurrently.

As another example, the site can track what interests a user has exhibited to the site and orient the user's website experience based upon the historical interests that the user has communicated directly or indirectly through the site. For example, if a user has previously viewed many kayaking videos or kayaking cultural items on the site, then kayaking-related items can be given a greater weighting when determining what items to display to a user when the user has selected a non-kayaking item (e.g., mountain biking).

As yet another example, it should be understood that the systems and methods disclosed herein relate to many different applications, such as sports-related activities, entertainment, culinary, arts, general community websites, etc.

It is further noted that the systems and methods may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A method for providing access to media digital assets through a web site, comprising:
receiving a media digital asset from a user over a communications network;
wherein the media digital asset is a proprietary asset of the user;
wherein the user has an agreement with respect to the media digital asset so that the received media digital asset is exclusively available through the web site;
wherein the user is a member of a group focused on a predetermined interest;
wherein the interest has been identified as an interest for which media digital assets are being generated or have been generated by people associated with the interest;
determining whether to allow access of the received media digital asset to select members within the group or to publish the received media digital asset to the group;
storing the media digital asset with other assets within a data store; and
providing, to the group, access to the received media digital asset in accordance with the determined access rights.

2. The method of claim 1, wherein the data store stores disparate types of media digital assets.

3. The method of claim 1, wherein the agreement includes a purchase provision related to media digital assets received from the user.

4. The method of claim 1, wherein the agreement includes an exclusive licensing provision or co-ownership provision related to media digital assets received from the user.

5. The method of claim 1, wherein the interest is a niche sports-related interest for which a community of users exists.

6. The method of claim 5, wherein the niche sports-related interest is identified as being associated with a community that is media and content oriented.

7. The method of claim 5, wherein because the interest is a sports-related niche interest, probability is increased for obtaining media digital content that is relevant to people having the sports-related niche interest.

8. The method of claim 7, wherein the web site integrates a social network and virtual community for people having the sports-related niche interest.

9. The method of claim 8 further comprising:
associating content creator identification information with the stored media digital asset;
wherein when members of the group view the media digital asset, the content creator identification information is provided to said viewing members, thereby providing incentive for the user to submit content and create an identity within the group.

10. The method of claim 1 further comprising:
monitoring access by the group of the stored media digital assets;
determining popularity metrics based upon the monitored accessing of the media digital assets;
wherein an exclusive relationship is established with a user whose popularity metric for a media digital asset satisfies a predetermined criterion.

11. The method of claim 10, wherein the popularity metrics are based upon number of accesses by users of the stored media digital assets.

12. The method of claim 1 comprising:
receiving search input for searching a plurality of media digital assets stored in the data store;
wherein metadata is associated with the media digital assets;
using the metadata associated with the media digital assets to determine an asset's relevance with respect to the received search input;
ranking the media digital assets based upon the determined assets' relevance;
retrieving media digital assets from the data store based upon the ranking of the media digital assets;
automatically displaying the retrieved media digital assets on a display device.

13. The method of claim 12, wherein a data structure is used to associate the metadata with the media digital assets;
wherein only a pre-specified list of values populate the data structure, thereby preventing users from providing random key words for searching.

14. The method of claim 13, wherein the media digital assets are associated with a pre-specified category, thereby allowing focused terms to be used to populate the data structure.

15. The method of claim 1, wherein the received media digital asset includes print media, VHS/DVD media, or film media.

16. The method of claim 1, wherein the user acts on behalf of a third party who owns the media digital asset.

17. A system for providing access to media digital assets through a web site, comprising:
a computer system for receiving a media digital asset from a user over a communications network;
wherein the media digital asset is a proprietary asset of the user;
wherein the user has an agreement with respect to the media digital asset so that the received media digital asset is exclusively available through the web site;
wherein the user is a member of a group focused on a predetermined interest;
wherein the interest has been identified as an interest for which media digital assets are being generated or have been generated by people associated with the interest;
software instruction to determine whether to allow access of the received media digital asset to select members within the group or to publish the received media digital asset to the group;
a data store to store the media digital asset with other assets; and
wherein access is provided to the group with respect to the received media digital asset in accordance with the determined access rights.

18. A method for providing a social networking platform in order to access data items through a web site, comprising:
using a common metadata structure to tag a plurality of disparate data items, thereby associating metadata tagging information with each disparate data item;
receiving search input for searching the plurality of disparate data items stored in a data store;
using the metadata tagging information associated with the disparate data items to determine a data item's relevance with respect to the received search input;
ranking the disparate data items based upon the determined data items' relevance;
retrieving disparate data items from the data store based upon the ranking of the disparate data items;
automatically displaying the retrieved disparate data items on a display device.

19. The method of claim 18, wherein the data items are disparate with respect to type of data item;
wherein disparate types of data items include a content-related type of data item, a culture-related type of data item, a community-related type of data item, a commerce-related type of data item, and an advertisement-related type of data item.

20. The method of claim 18, wherein only a pre-specified list of values are used for searching, thereby preventing users from providing random key words for searching.

21. The method of claim 20, wherein the disparate data items are associated with a pre-specified category, thereby allowing focused terms to be used for the searching.

22. The method of claim 18, wherein the ranking of the disparate data items are selected based upon their degree of interrelatedness with a pre-specified data item;
wherein display of the selected data items' locations relative to the pre-specified data item is based upon their respective degree of interrelatedness with respect to the pre-specified data item.

23. The method of claim 22, wherein display of the selected disparate data items allows connections among disparate types of information to be surfaced to a user.

24. The method of claim 22, wherein the connections among the disparate types of information facilitates social networking for users of a website.

25. The method of claim 24, wherein disparate types of information include content-related information, culture-related information, community-related information, commerce-related information, and advertisement-related information.

26. The method of claim 25, wherein the connection to community-related information allows a user of a website to associate with other users with respect to one or more similar interests.
